(19) United States
(12) Patent Application Publication
(10) Pub. No.: US 2025/0170880 A1
(43) Pub. Date: May 29, 2025

(54) Rail Mounted Retractable Cover; Pivotable Retractable Bed Cover for a Pickup Truck; Tiltable Retractable Bed Cover for a Pickup Truck; Post-Mounted Retractable Cover; Track Mounted Retractable Cover; Magnetically Actuated Retractable Cover; and Retractable Bed Cover and Rear Window Protector for a Pickup Truck

(71) Applicant: Adaptive Aerodynamic, LLC, Maple Grove, MN (US)

(72) Inventor: Thomas Scott BREIDENBACH, Maple Grove, MN (US)

(21) Appl. No.: 19/040,859

(22) Filed: Jan. 29, 2025

Related U.S. Application Data
(60) Provisional application No. 63/604,182, filed on Nov. 29, 2023.

(51) Int. Cl. B60J 7/04; B60J 7/19

(52) U.S. Cl. CPC B60J 7/041; B60J 7/198

(57) ABSTRACT

The presently claimed and described technology provides apparatuses including a rail mounted retractable cover, a tiltable retractable bed cover for a pickup truck, a post-mounted retractable cover, a track mounted retractable cover, a magnetically actuated retractable cover, and a retractable bed cover and rear window protector for a pickup truck. The cover may be driven between a deployed (extended) configuration, a retracted (stowed) configuration, and a tilted configuration.

### CROSS REFERENCE TO RELATED APPLICATIONS

The present application claims the benefit of U.S. Provisional Patent Application Ser. No. 63/604,182, entitled Rail Mounted Retractable Cover; Tiltable Retractable Bed Cover for a Pick-Up Truck; Post-Mounted Retractable Cover; Track Mounted Retractable Cover; Magnetically Actuated Retractable Cover; and Retractable Bed Cover and Rear Window Protector for a Pick-Up Truck, and filed on Nov. 29, 2023, the disclosure of which is hereby incorporated by reference in its entirety. The present application is related to U.S. Provisional Patent Application Ser. No. 63/334,668, entitled Rodless Actuator with Deterministic Actuation; Rodless Actuator System with Coordinated Actuators; Rail Mounted Retractable Cover; and Retractable Aerodynamic Apparatus for a Pickup Truck, and filed on Apr. 26, 2022, and to U.S. Non-Provisional patent application Ser. No. 18/139,944, entitled Rodless Actuator; Rodless Actuator with Drive Element Positioned within a Rail Tube; Rail Mounted Retractable Cover; and Retractable Aerodynamic Apparatus for a Pick-Up Truck, filed on Apr. 26, 2023, and now U.S. Patent Application Publication No. US 2023/0382205 A1, published Nov. 30, 2023, the disclosures of which are hereby incorporated by reference in their entireties.

### FIELD

Various aspects of the presently disclosed and claimed technology relate to retractable bed covers and rear window protection devices for pickup trucks, and the like.

### BACKGROUND

Retractable covers are commercially available for pickup truck boxes/beds. It is often desired to actuate such covers between a deployed configuration and a retracted configuration. In certain applications and/or for certain operators/owners, it may be desirable to easily remove and/or reinstall such covers and thereby further provide a removed configuration.

Rear window protectors are commercially available for pickup trucks. Such protectors typically include a meshed material, louvers, bars, etc. that serve as element(s) of a barrier to protect the rear window from at least objects too large to fit between/within the element(s).

Aftermarket and/or dealer supplied accessories for pickup trucks may include pickup truck box covers (i.e., tonneau covers), toppers (i.e., camper shells, box cap, etc.), side rails (i.e., bed side rails, bed racks, etc.), and racks (i.e., bed racks, etc.) that are positioned above the side of the pickup truck box. However, such accessories may only provide a single function, may interfere with and/or be incompatible with other box mounted accessories, may substantially intrude into otherwise useable space of the pickup truck box/bed, and/or are not integrated with other box mounted accessories.

Certain aftermarket and/or dealer supplied pickup truck box covers have limited strength and/or are mounted with low-strength extrusions, sheet metal, and/or clamps that may attach to low-strength sheet metal of the pickup truck box. Such limited strength covers cannot carry substantial loads, cannot be walked on, and/or are vulnerable to being forced open when closed.

Thus, there is a need for a rail and/or track mounted retractable cover for a pickup truck box/bed. There is a further need for such rails and/or tracks to not intrude into otherwise useable space of the pickup truck box/bed. There is a further need for such retractable covers to pivot out of the way to provide full or nearly full access to the box/bed. There is a further need for such retractable covers to permit the pickup truck to travel when such retractable covers are in a pivoted configuration, including travel at highway speeds. There is a further need for such retractable covers to provide rear window protection for the pickup truck. There is a further need for such retractable covers to be easily removable. There is a further need for such retractable covers to have a post mounting. There is a further need for such retractable covers to be actuated between covered and uncovered configurations. There is a further need for such retractable covers to be actuated between pivoted and unpivoted configurations. There is a further need for such retractable covers and corresponding mounting hardware to have high-strength so that the covers can be walked on and/or carry substantial loads, e.g., when closed and/or unpivoted. There is a further need for such retractable covers to be adapted for stake pocket (i.e., stake hole) mounting to the pickup truck box. Such stake pockets are typically high-strength in comparison to the sheet metal box features that certain conventional covers are mounted to.

Further limitations and disadvantages of conventional and/or traditional prior art covers, retractable covers, and/or rear window protectors for pickup trucks will become apparent to one of skill in the art, through comparison of such mechanisms and/or methods with certain aspects of the present disclosure, as set forth in the remainder of the present application with reference to the drawings.

### BRIEF SUMMARY

According to the principles of the present disclosure, a retractable cover for a pickup truck may include various features, discussed below, in various combinations, including a single one of these features, a single set of related features, or any compatible combination of features. Use of the words “may be” and “may” herein typically imply optional usage that is not required for every embodiment, as will be clear to one of ordinary skill in the art. However, certain embodiments of the present disclosure (e.g., claimed features of a particular claim) do require such usage, as will be clear to one of ordinary skill in the art. Thus, sections that include the words “may be” can be rewritten/amended by replacing at least some of the words “may be” with the word “is” or the word “are” and thereby require usage for a particular embodiment but not necessarily for all embodiments. Likewise, sections that include the word “may” can be rewritten/amended by removing at least some of the word(s) “may” thereby requiring usage for a particular embodiment but not necessarily for all embodiments. Such rewritten/amended language can replace the original language and/or can be added to an amendment for clarification.

The retractable cover may be rail-mounted and/or retained. Certain operators/owners may desire both rails and a retractable cover for their pickup truck, at least in certain applications. Rails (i.e., bed rails) typically include front and rear mounts (or at least discrete mounts) with open space under a rail component (e.g., a tube) between the mounts. The rails may be stake pocket (i.e., stake hole) mounted. Certain prior art rails and prior art retractable covers may be incompatible with each other and/or include undesired limitations and/or compromises when used together. Such prior art covers may include a retraction-extension mechanism separate from such prior art rails. According to the principles of the present disclosure, making use of rails as both functional rails and as a component of a retraction-extension mechanism for the retractable cover may save cost, weight, space, etc. One or more panels and/or other components of the retractable cover may be supported, guided, retained, constrained, and/or actuated by one or more of the rails. E.g., the rail(s) may provide a track for slides/rollers of the cover to ride on while the cover is being extended and/or retracted. Such rails may include one or more features (the features may include functional features and/or the same or similar overall appearance) of conventional and/or prior art pickup truck rails (i.e., bed rails) and/or may be similarly used. Such rails may provide a high-strength mount for the cover and/or complement a high-strength cover.

The retractable cover may be track-mounted and/or retained. In certain embodiments, the rails (i.e., bed rails) mentioned in the preceding paragraph may be undesired. E.g., it may be undesired to use vertical space that would be occupied by the rails, a lower profile cover may be desired that is incompatible with including rails, the appearance of the rails may be undesired, strength of a span of the rails may be inadequate and/or require inefficient material use, cost and/or weight of the rails may be undesired, etc. However, some or all of the features of the cover may be adapted to use one or more rail-less tracks in place of the rails and/or tracks of the rails. Furthermore, the track(s) may be integrated with/incorporated into the pickup truck. E.g., a flange or a pair of opposite flanges of the pickup truck box may include the tracks, and, for example, the slides, rollers, etc. of the cover may be supported, guided, retained, constrained, and/or actuated by such tracks.

The retractable cover may be magnetically actuated. One or more magnetic couples may be included with an actuation system of the cover. The magnetic couple(s) may include a first magnetic component directly or indirectly driven by a corresponding actuator and a second magnetic component directly or indirectly attached to one or more of the panels of the cover. The first and second magnetic components may be continuously or intermittently magnetically coupled to each other and thereby continuously or intermittently couple the actuator(s) to the panel(s) of the cover. At least a portion of the actuation system may be positioned within the above-mentioned rails (e.g., within the tube), may be positioned within and/or underneath the above-mentioned tracks, and/or may be positioned within and/or underneath a portion of the pickup truck (e.g., within the flange(s), beneath a top(s) of a wall(s) of the pickup truck box, beneath a cover(s) of the wall(s), etc.). The actuator thereby may be protected from environmental contamination, may be protected from vandalism and/or theft, may be hidden from view (providing a clean appearance), may conserve space, may be shielded (i.e., provided a safety shield to protect objects and people from becoming entangled with the actuator, etc.). The magnetic couple may extend across what the actuation system or portion thereof is within, beneath, shielded by, etc. and thereby transfer actuation (e.g., magnetically) across such barriers.

Magnets of the above-mentioned first and second magnetic components of the magnetic couple may be oriented in a V-shaped configuration and thereby provide both strong rotational and strong linear magnetic coupling. The polarity of the magnets may alternate along a length of the couple and/or between banks of the V-shape. Thus, a polarity of a given magnet may be reversed in neighboring magnets along the length, on the opposite bank, and on the opposite magnetic component of the couple. The V-shaped configuration may adequately constrain the opposite magnetic components of the couple to each other without a need for a third constrain for one or both of the magnetic components. (First and second constraints may be formed on the first and second banks of the V-shape.) Eliminating the need for the third constraint may accommodate use of lower tolerance material on the rails and/or the tracks while preventing and/or minimizing looseness, binding, rattling, etc.

The retractable cover may be screw actuated. The actuation system of the cover may include one or more screw actuators. The screw actuator(s) may include ball screw(s) and ball nut(s), roller screw(s) and roller nut(s), lead screw(s) and lead nut(s), etc. The screw actuator(s) may be right-hand threaded, left-hand threaded, or both right-hand and left-hand threaded (e.g., right-hand threaded on a right actuator and left-hand threaded on a left actuator or vise-versa). As mentioned above, at least a portion of the screw actuator(s) may be positioned within, underneath, etc. other portions/components of the cover and/or pickup truck. As discussed above, the screw actuator(s) may be magnetically coupled to the panel(s) of the cover.

The retractable cover may be tension member actuated. The actuation system of the cover may include one or more tension members. The tension member(s) may include belt(s) (e.g., timing belts, V-belts, etc.), chains(s) (e.g., bead chains, roller chains, etc.), rope(s) (wire ropes, cables, cords, etc.) and/or other forms of tension members. As mentioned above, at least a portion of the tension member(s) may be positioned within, underneath, etc. other portions/components (e.g., rails, flanges, etc.) of the cover and/or pickup truck. As discussed above, the tension member(s) may be magnetically coupled to the panel(s) of the cover.

The retractable cover may be powered (e.g., electrical, hydraulic, pneumatic, etc.).

The retractable cover may be spring actuated. The actuation system of the cover may include one or more springs (e.g., tension springs, compression springs, torsion springs, disc springs, wave springs, rotor springs, combination springs, etc.). The spring actuation may operate in one direction and may require resetting in the other direction. Catch(es), latch(es), magnets, etc. may be used to hold energy within the spring(s) and released to provide actuation. The spring actuation may assist other forms of actuation. As mentioned above, at least a portion of the spring(s) may be positioned within, underneath, etc. other portions/components (e.g., rails, flanges, etc.) of the cover and/or pickup truck. As discussed above, the spring(s) may be magnetically coupled to the panel(s) of the cover.

The retractable cover may be manually actuated. The actuation system of the cover may be manually actuated by an operator and thereby require no powered actuator (e.g., electrical, hydraulic, pneumatic, etc.).

The retractable cover may include hidden fasteners. The hidden fasteners may be non-viewable from typical driver, operator, passenger, and/or onlooker viewing perspectives. The rails and/or tracks may be attached to the pickup truck from fasteners installed from beneath the pickup truck.

The retractable cover may be tiltable (i.e., pivotable). To provide access to most of or all of the pickup truck bed/box, the cover may tilt (i.e., pivot). The tilting (i.e., pivoting) may occur after sliding retraction. The tilting/pivoting may be 90 degrees or more. The tilting/pivoting may be less than 90 degrees. A tilted (i.e., pivoted) configuration of the cover may position the cover adjacent a rear end of a cab of the pickup truck. An initial retraction may include the cover generally linearly sliding along the above-mentioned rails/tracks, thereby exposing/uncovering a first portion of the bed/box. The initial retraction may be followed by the tilting (i.e., pivoting) of the cover, thereby exposing/uncovering a second portion of the bed/box. The bed/box may be substantially or entirely exposed/uncovered by the initial retraction and the tilting of the cover. The retractable cover may be integrated with a rear window protection apparatus. In certain embodiments, the cover may be tilted/pivoted without retraction. In certain embodiments, the cover may be supported and/or retained by a prop rod when tilted/pivoted.

Weight of the retractable cover may be counterbalanced to facilitate the above-mentioned tilting/pivoting and/or an actuator may be provided for the tilting/pivoting. The counterbalancing may be provided by a spring (e.g., a torsional spring). The counterbalancing may be provided by a counterweight.

A tilt/pivot-lock may be provided to lock (i.e., secure) the retractable cover at the tilted/pivoted configurations. The tilt-lock may allow over-the-road travel with the cover tilted/pivoted. The pivoted configuration may provide rear window protection for the pickup truck.

A camera may be provided to provide a rearward view (e.g., via a video screen in the cab). The rearward view may be similar to or the same as a conventional view via an interior-mounted rear view mirror. The camera and corresponding video screen may operate (e.g., automatically operate) at least when the retractable cover is at the tilted/pivoted configurations. The screen may be integrated with the rear view mirror and/or an interior multi-function screen. The camera may be positioned under the retractable cover when the retractable cover is at the deployed configuration, and/or the camera may be positioned at a viewing position (e.g., by the retractable cover) when the retractable cover is at the tilted/pivoted configurations. View blockage (e.g., rear window view blockage) by the retractable cover when at the pivoted configuration (e.g., a rear window protecting configuration) may be at least partially mitigated by the camera(s) and video display screen(s).

The retractable cover may be post-mounted. To accommodate removal/reinstallation of the cover, the rails, the tracks, and/or the bed/box of the pickup truck may be configured to interface with one or more mounting posts of the cover. To case removal/reinstallation of the cover, quick-disconnect/reconnect fasteners, hand-applied fasteners, and/or only a single/a pair of fasteners may be used to attach the mounting post(s). Electrical connection and/or other (e.g., optical) connection between the pickup truck and the cover may be automatically established by mounting the mounting post(s). E.g., the connection(s) may transmit electrical power, control signal(s), and/or sensor signal(s). Such connections may be done wirelessly. Such connections may be integrated into a harness, a power system, and/or a control system of the pickup truck. The mounting posts may be on the cover or on the rails with an opposite post receiver on the rails or on the cover or vise-versa.

The retractable cover may include releasable retainers/guides. To accommodate easy removal and/or tilting/pivoting of the cover, releasable rail/track retainers may be used to mount the cover to the pickup truck. The releasable retainers may be included on the cover, on the rail, on the track, and/or on the pickup truck box.

The retractable cover may include a single point of actuation for some or all of the various functions and/or differential actuation of two or more functions.

The retractable cover may be lockable (e.g., with a physical key, a wireless remote, etc.) and include multiple lockable configurations (e.g., only tilting is locked).

The retractable cover may include telescoping panels.

The retractable cover may include inter-panel linkage constraints.

The retractable cover may include inter-panel telescopic constraints.

These and other advantages, aspects, and novel features of the present disclosure, as well as the details of illustrated embodiments thereof, will be more fully understood from the following description and drawings.

### BRIEF DESCRIPTION OF THE FIGURES

Embodiments of the present disclosure will now be described, by way of example only, with reference to the attached Figures, wherein:

FIG. 1 is a perspective view of an example retractable cover at an extended (deployed) configuration mounted over an example box of an example pickup truck with extension locks of the cover at a locked configuration, in accordance with the principles of the present disclosure;

FIG. 2A is a cutaway perspective view of a portion of the cover of FIG. 1, as called out at FIG. 1, illustrating an actuator of one of the extension locks of FIG. 1 at the locked configuration of FIG. 1 and shown with magnets of the outer magnetic couple of FIG. 70A removed;

FIG. 2B is the perspective view of FIG. 2A, but only showing the one extension lock;

FIG. 3A is a partial perspective view, as called out at FIG. 1, illustrating an example recessed actuating handle of the cover of FIG. 1, in accordance with the principles of the present disclosure;

FIG. 3B is a partial perspective cutaway view of the cover of FIG. 1, as called out at FIG. 1, illustrating the handle of FIG. 3A deployed and actuating members of the cover operably connected to the handle, in accordance with the principles of the present disclosure;

FIG. 3C is the partial perspective view of FIG. 3A, as called out at FIG. 1, but with the handle of FIG. 3A deployed and rotated, in accordance with the principles of the present disclosure;

FIG. 4 is a portion of the perspective view of FIG. 1, but with the extension locks of FIG. 1 at an unlocked configuration, in accordance with the principles of the present disclosure;

FIG. 5 is a cutaway perspective view of a portion of the cover of FIG. 1, as called out at FIG. 4, illustrating one of the extension locks of FIG. 1 at the unlocked configuration of FIG. 4, a portion of a first actuator at an extended configuration, and magnets of the magnetic couples of FIGS. 69A & 70A, in accordance with the principles of the present disclosure;

FIG. 6 is a portion of the perspective view of FIG. 1, but with the cover of FIG. 1 at a retracted (first stowed) configuration (untilted/unpivoted), in accordance with the principles of the present disclosure;

FIG. 7 is a partial cross-sectional elevation view of the cover of FIG. 1, as called out at FIGS. 6 & 62B, illustrating a cover assembly of the cover attached to a rail/track set of the cover via rail/track retainers configured at a retaining configuration and thereby retaining the cover assembly to the rail/track set and further illustrating the first actuator of FIG. 5 at a retracted configuration, in accordance with the principles of the present disclosure;

FIG. 8 is a partial cross-sectional elevation view of the cover of FIG. 1, as called out at FIG. 6, illustrating the rail/track retainers of FIG. 7 configured at a non-retaining configuration and thereby not retaining the cover assembly of FIG. 7 to the rail/track set of FIG. 7, in accordance with the principles of the present disclosure;

FIG. 9 is a partial perspective cutaway view of the cover and the pickup truck of FIG. 1 illustrating the cover at a pivoted/tilted (second stowed) configuration with the cover assembly of FIG. 7 positioned adjacent an example cab portion of the pickup truck with a pivot/tilt lock of the cover at an unlocked configuration, in accordance with the principles of the present disclosure;

FIG. 10A is a perspective view of the cover and the pickup truck of FIG. 1 illustrating the cover at the pivoted/tilted configuration of FIG. 9 and transverse contours of the pickup truck and cover and further schematically illustrating a control system enclosure;

FIG. 10B is a partial side elevation view of the cover of FIG. 1 and a longitudinal contour of the pickup truck of FIG. 1 illustrating the cover at the pivoted/tilted configuration of FIG. 9;

FIG. 11 is a partial perspective view of the cover of FIG. 1, as called out at FIG. 9, illustrating the cover at the pivoted/tilted configuration of FIG. 9 and the pivot/tilt lock of FIG. 9 at the unlocked configuration of FIG. 9;

FIG. 12 is a partial perspective view of the cover of FIG. 1, as called out at FIG. 10A, illustrating the cover at the pivoted/tilted configuration of FIG. 9 and the pivot/tilt lock of FIG. 9 at a locked configuration, in accordance with the principles of the present disclosure;

FIG. 13 is a partial exploded perspective view of the cover of FIG. 1 illustrating the cover assembly of FIG. 7 removed from the rail/track set of FIG. 7 (and thereby further removed from the pickup truck of FIG. 1), in accordance with the principles of the present disclosure;

FIG. 14 is a portion of the perspective view of FIG. 1, but with the cover assembly of FIG. 7 removed from the rail/track set of FIG. 7 and thereby from the pickup truck of FIG. 1 and schematically illustrating a pair of stake pockets;

FIG. 15 is a partial exploded perspective view of the rail/track set of FIG. 7 illustrating a front tube removed from the rail/track set (and thereby further removed from the pickup truck of FIG. 1), in accordance with the principles of the present disclosure;

FIG. 16 is the partial perspective view of FIG. 14, but with the front tube of FIG. 15 removed from the rail/track set of FIG. 7 (and thereby further removed from the pickup truck of FIG. 1);

FIG. 17A is a partial perspective view of the cover assembly of FIG. 7, as called out at FIG. 10A, illustrating the actuating members of FIG. 3B operably connected to the handle of FIG. 3A and at a first configuration, in accordance with the principles of the present disclosure;

FIG. 17B is a portion of the perspective view of FIG. 17A, but with the actuating members of FIG. 3B at a second configuration, in accordance with the principles of the present disclosure;

FIG. 17C is a portion of the perspective view of FIG. 17A, but with the actuating members of FIG. 3B at a third configuration, in accordance with the principles of the present disclosure;

FIG. 17D is a portion of the perspective view of FIG. 17A, but with the actuating members of FIG. 3B at a fourth configuration, in accordance with the principles of the present disclosure;

FIG. 18 is a partial perspective view of a portion of the cover of FIG. 1, as called out at FIG. 9, illustrating a differential device of the cover driven by the actuating members of FIG. 3B (at the first configuration of FIG. 17A), the differential device, in turn, driving a first device (at a first configuration) and a second device (locked at a first configuration), in accordance with the principles of the present disclosure;

FIG. 19 is a partial cross-sectional upside-down elevation view, as called out at FIGS. 18 & 32, illustrating a mechanism of the first device of FIG. 18 that drives the extension lock of FIGS. 1 & 5, the pivot/tilt lock of FIG. 9, and a first cover assembly retraction keeper (further illustrated at FIGS. 42 & 43A-C), in accordance with the principles of the present disclosure;

FIG. 20 is a partial upside-down elevation view, as called out at FIG. 18, illustrating a mechanism of the second device of FIG. 18 that drives the rail/track retainers of FIG. 7 (at the retaining configuration of FIG. 7) and a second cover assembly retraction keeper (further illustrated at FIGS. 38, 40, & 41), in accordance with the principles of the present disclosure;

FIG. 21 is a partial cross-sectional view, as called out at FIG. 20, illustrating a lock (e.g., a rail/track retainer lock and/or a second device lock) at a locked configuration of the second device of FIG. 18, in accordance with the principles of the present disclosure;

FIG. 22 is an enlarged portion of FIGS. 18 & 32, as called out at FIGS. 18 & 32, illustrating a first pivot/tilt lock engageable portion (at a first position) of the first device of FIG. 18;

FIG. 23 is a partial perspective view of a portion of the cover of FIG. 1, as called out at FIG. 9, illustrating the differential device of FIG. 18 driven by the actuating members of FIG. 3B (at the second configuration of FIG. 17B), the differential device, in turn, driving the first device of FIG. 18 (at a second configuration) and the second device of FIG. 18 (locked and unlocked at the first configuration of FIG. 18), in accordance with the principles of the present disclosure;

FIG. 24 is the partial cross-sectional view of FIG. 19, but as called out at FIGS. 23 & 27 and with the mechanism of FIG. 19 and the extension lock of FIGS. 1 & 5 reflecting the first device of FIG. 18 at the second configuration of FIG. 23, in accordance with the principles of the present disclosure;

FIG. 25 is a portion of the perspective view of FIG. 18, as called out at FIG. 18, but with the lock of FIG. 21 at an unlocked configuration, in accordance with the principles of the present disclosure;

FIG. 26 is the partial cross-sectional view of FIG. 21, as called out at FIG. 20, but with the lock of FIG. 21 at the unlocked configuration of FIG. 25;

FIG. 27 is the partial perspective view of FIG. 18, as called out at FIG. 9, but illustrating the differential device of FIG. 18 driven by the actuating members of FIG. 3B at the third configuration of FIG. 17C, the differential device, in turn, driving the first device of FIG. 18 at the second configuration of FIG. 23 and the second device of FIG. 18 at a second configuration (unlocked), in accordance with the principles of the present disclosure;

FIG. 28 is the partial elevation view of FIG. 20, but as called out at FIG. 27 and illustrating the mechanism of FIG. 20 of the second device of FIG. 18 driving the rail/track retainers of FIG. 7 at the non-retaining configuration of FIG. 8, in accordance with the principles of the present disclosure;

FIG. 29 is a partial cross-sectional view, as called out at FIG. 28, illustrating the lock of FIG. 21 of the second device of FIG. 18 at the unlocked configuration of FIG. 25 and further rotated;

FIG. 30 is an enlarged portion of FIGS. 23 & 27, as called out at FIGS. 23 & 27, illustrating the first pivot/tilt lock engageable portion of FIG. 22 (at a second position) of the first device of FIG. 18;

FIG. 31 is a partial perspective view of a portion of the cover of FIG. 1, as called out at FIG. 6, illustrating a portion of a restraining mechanism of the rail/track retainers of FIG. 7 shown at a first configuration (solid line) and at a second configuration (dashed line), in accordance with the principles of the present disclosure;

FIG. 32 is the partial perspective view of FIG. 23, as called out at FIG. 9, but illustrating the differential device of FIG. 18 driven by the actuating members of FIG. 3B at the fourth configuration of FIG. 17D, the differential device, in turn, driving the first device of FIG. 18 at the first configuration of FIG. 18 and the second device of FIG. 18 at the second configuration of FIG. 27 (restrained by the restraining mechanism of FIG. 31 and with the lock of FIG. 21 unlocked), in accordance with the principles of the present disclosure;

FIG. 33 is an exploded perspective view of a portion of one of the rail/track retainers of FIG. 7, including a portion of another lock (i.e., of FIG. 21 serving as a rail/track retainer lock), a first rail/track retainer engageable portion, and a second rail/track retainer engageable portion, in accordance with the principles of the present disclosure;

FIG. 34 is a partial perspective view of a portion of the cover of FIG. 1, illustrating a portion of the pivot/tilt lock of FIG. 9 (at the unlocked configuration of FIG. 9) including a second pivot/tilt lock engageable portion configured to selectively engage the first pivot/tilt lock engageable portion of FIG. 22 and further including a rail/track retainer lock release feature, in accordance with the principles of the present disclosure;

FIG. 35 is a partial perspective cutaway view of a portion of the cover of FIG. 1, at the stowed configuration of FIGS. 6 and/or 9, illustrating a stack of the rail/track retainer locks of FIG. 21, at the unlocked configuration of FIG. 25 via the stowed configuration positioning the stack against the rail/track retainer lock release feature of FIG. 34, and further illustrating an alternating stack of the first and second rail/track retainer engageable portions engaged with each other via the stowed configuration, in accordance with the principles of the present disclosure;

FIG. 36 is a perspective view of a member of the pivot/tilt lock of FIG. 9 illustrating the second pivot/tilt lock engageable portion of FIG. 34 and a detent ball, in accordance with the principles of the present disclosure;

FIG. 37 is a perspective view of a member of the first device of FIG. 18 that drives the pivot/tilt lock of FIG. 9 via the first pivot/tilt lock engageable portion of FIG. 22 (engaging the second pivot/tilt lock engageable portion of FIG. 34), in accordance with the principles of the present disclosure;

FIG. 38 is a perspective view of the pivot/tilt lock of FIG. 9 adjacent one of the rail/track retainers of FIG. 7 (at the retaining configuration of FIG. 7) and mounted on a mount (dashed lines) of the cover assembly of FIG. 7 (see FIG. 55D) illustrating the detent ball of FIG. 36 engaged with a first detent pocket of the mount thereby releasably holding the pivot/tilt lock at the unlocked configuration of FIG. 9, illustrating a second cover assembly retraction keeper (see also the FIG. 20 description) at a disengaged configuration, and illustrating the pivot/tilt lock engageable portions of FIGS. 22 & 34 engaged, in accordance with the principles of the present disclosure;

FIG. 39 is a partial perspective view of a portion of the cover of FIG. 1, further illustrating the pivot/tilt lock of FIG. 9 mounted and detented to the mount of FIG. 38 and the rail/track retainers of FIG. 7 at the non-retaining configuration of FIG. 8;

FIG. 40 is a partial perspective cutaway view of a portion of the cover of FIG. 1, illustrating the second cover assembly retraction keeper of FIG. 38 at an engaged configuration, illustrating the pivot/tilt lock engageable portions of FIGS. 22 & 34 engaged, and illustrating the detent ball of FIG. 36 (hidden) engaged with a second detent pocket (hidden) of the mount of FIG. 38 thereby releasably holding the pivot/tilt lock at the locked configuration of FIG. 12;

FIG. 41 is a partial perspective cutaway view of a portion of the cover of FIG. 1, further illustrating the second cover assembly retraction keeper of FIG. 38 at the engaged configuration of FIG. 40 and further illustrating the lock of FIG. 21 at the unlocked configuration of FIG. 25 and further rotated, as also shown at FIG. 29;

FIG. 42 is a partial perspective view of a portion of the cover of FIG. 1, illustrating a first cover assembly retraction keeper (see also the FIG. 19 description) at a partially engaged configuration, in accordance with the principles of the present disclosure;

FIG. 43A is a partial perspective view of a portion of the first cover assembly retraction keeper of FIG. 42 illustrating a slotted tube prior to engagement with a rotatable pin actuated by the first device of FIG. 18, in accordance with the principles of the present disclosure;

FIG. 43B is the partial perspective view of FIG. 43A, but with the rotatable pin of FIG. 43A inserted through a linear portion of a slot of the slotted tube of FIG. 43A (e.g., by the first actuator of FIG. 5 moving from the extended configuration of FIG. 5 to the retracted configuration of FIG. 7), in accordance with the principles of the present disclosure;

FIG. 43C is the partial perspective view of FIG. 43A, but with the rotatable pin of FIG. 43A inserted into a rotational portion of the slot of FIG. 43B (e.g., by the first device of FIG. 18 moving from the second configuration of FIGS. 23 & 27 to the first configuration of FIGS. 18 & 32) and thereby securing the cover assembly of FIG. 7 at a retracted configuration (corresponding to the cover at FIG. 6), in accordance with the principles of the present disclosure;

FIG. 44 is a perspective view of a component of the first device of FIG. 18 configured to hold and actuate (e.g., rotationally) the rotatable pin of FIG. 43A;

FIG. 45 is a partial perspective view of the cover assembly of FIG. 7 illustrated at an extended configuration corresponding to the cover at FIG. 1 (i.e., at the extended configuration of FIG. 1) and with the extension lock of FIG. 1 at the locked configuration of FIG. 1;

FIG. 46 is an enlarged portion of FIG. 45, as called out at FIG. 45;

FIG. 47 is a partial perspective view of the cover assembly of FIG. 7 illustrated at the extended configuration of FIG. 45 and with the extension lock of FIG. 1 at the unlocked configuration of FIG. 4;

FIG. 48 is an enlarged portion of FIG. 47, as called out at FIG. 47;

FIG. 49 is an enlarged portion of FIG. 47, as called out at FIG. 47;

FIG. 50 is a partial perspective cutaway view of a portion of the cover of FIG. 1 at the pivoted/tilted configuration of FIG. 9, but with the pivot/tilt lock of FIG. 9 at the locked configuration of FIG. 12, illustrating stowed (retracted) configurations of a first and a second panel interconnection arrangement, in accordance with the principles of the present disclosure;

FIG. 51 is an enlarged portion of FIG. 50, as called out at FIG. 50;

FIG. 52 is an enlarged portion of FIG. 50, as called out at FIG. 50;

FIG. 53 is an enlarged portion of FIG. 50, as called out at FIG. 50;

FIG. 54 is an enlarged portion of FIG. 50, as called out at FIG. 50, but with a first arm of the first panel interconnection arrangement of FIG. 50 shown transparently in dashed line to reveal a second arm of the first panel interconnection arrangement, in accordance with the principles of the present disclosure;

FIG. 55A is a perspective view of a first panel of the cover assembly of FIG. 7;

FIG. 55B is an enlarged portion of FIG. 55A, as called out at FIG. 55A;

FIG. 55C is an enlarged portion of FIG. 55A, as called out at FIG. 55A;

FIG. 55D is an enlarged portion of FIG. 55A, as called out at FIG. 55A;

FIG. 55E is an enlarged portion of FIG. 55A, as called out at FIG. 55A;

FIG. 56 is a perspective view of a second panel of the cover assembly of FIG. 7;

FIG. 57 is a perspective view of a third panel of the cover assembly of FIG. 7;

FIG. 58A is a perspective view of a fourth panel of the cover assembly of FIG. 7;

FIG. 58B is an enlarged portion of FIG. 58A, as called out at FIG. 58A;

FIG. 59A is a perspective view of a fifth (and last) panel of the cover assembly of FIG. 7;

FIG. 59B is an enlarged portion of FIG. 59A, as called out at FIG. 59A;

FIG. 60A is another perspective view of the last panel of FIG. 59A;

FIG. 60B is an enlarged portion of FIG. 60A, as called out at FIG. 60A;

FIG. 60C is an enlarged portion of FIG. 60A, as called out at FIG. 60A;

FIG. 61A is a cross-sectional elevation view of the cover of FIG. 1, as called out at FIG. 1, at the extended configuration of FIG. 1 illustrating the first actuator of FIG. 5 at the extended configuration of FIG. 5, in accordance with the principles of the present disclosure;

FIG. 61B is the cross-sectional view of FIG. 61A, as called out at FIG. 6, but with the cover at the retracted configuration of FIG. 6 and the first actuator of FIG. 5 at the retracted configuration of FIG. 7, in accordance with the principles of the present disclosure;

FIG. 62A is an enlarged portion of FIG. 61A, as called out at FIG. 61A;

FIG. 62B is an enlarged portion of FIG. 61B, as called out at FIG. 61B, further schematically illustrating a control system housed in the control system enclosure of FIG. 10A;

FIG. 63A is a partial broken cutaway perspective view of a portion of the first actuator of FIG. 5 illustrating a subassembly of components ready for insertion into an end of a rail tube of the first actuator, in accordance with the principles of the present disclosure;

FIG. 63B is the perspective view of FIG. 63A, but exploded;

FIG. 63C is a partial cutaway perspective view of another portion of the first actuator of FIG. 5 illustrating another subassembly of components insertable into/at another end of the rail tube of FIG. 63A, in accordance with the principles of the present disclosure;

FIG. 63D is the perspective view of FIG. 63C, but exploded;

FIG. 64A is a cross-sectional perspective view of an end component of the subassembly of FIG. 63C, in accordance with the principles of the present disclosure;

FIG. 64B is the perspective view of FIG. 64A, but illustrating an alternative end component, in accordance with the principles of the present disclosure;

FIG. 65 is a cutaway perspective view of a mounting subassembly of the subassembly of FIG. 63C and a mounting fastener, in accordance with the principles of the present disclosure;

FIG. 66 is a partial cross-sectional elevation view of the cover of FIG. 1, as called out at FIGS. 6 & 61B, illustrating a magnetic coupling of the cover, in accordance with the principles of the present disclosure;

FIG. 67 is a partial cross-sectional elevation view of the cover of FIG. 1, as called out at FIGS. 1 & 61A, illustrating the subassembly of FIG. 63C upon assembly to the cover, in accordance with the principles of the present disclosure;

FIG. 68 is a partial cross-sectional elevation view of the cover of FIG. 1, as called out at FIGS. 1 & 61A, illustrating a roller set of the cover, in accordance with the principles of the present disclosure;

FIG. 69A is a perspective view of an example inner magnetic couple of the magnetic coupling of FIG. 66, an example nut assembly, and an example inner roller system integrated with each other and suitable for use in the first actuator of FIG. 5, in accordance with the principles of the present disclosure;

FIG. 69B is the perspective view of FIG. 69A, but exploded;

FIG. 70A is a cutaway perspective view of an example outer magnetic couple of the magnetic coupling of FIG. 66 and an example outer roller system integrated with each other and the last panel of FIG. 59A and suitable for use in the first actuator of FIG. 5, in accordance with the principles of the present disclosure;

FIG. 70B is the perspective view of FIG. 70A, but exploded;

FIG. 71 is a partial cross-sectional view of the cover of FIG. 1, as called out at FIG. 66, and further illustrating the magnetic coupling of FIG. 66 and the inner and outer roller systems of FIGS. 69A & 70A, in accordance with the principles of the present disclosure;

FIG. 72 is a partial cross-sectional elevation view of the cover of FIG. 1, as called out at FIGS. 6 & 62B, illustrating a second actuator of the cover suitable for actuating the cover between the untilted/unpivoted configuration of FIG. 6 and the pivoted/tilted configuration of FIG. 9, in accordance with the principles of the present disclosure;

FIG. 73A is a partial perspective view of the second actuator of FIG. 72 illustrating a subassembly of components insertable into/at an end of the front tube of FIG. 15, in accordance with the principles of the present disclosure;

FIG. 73B is the perspective view of FIG. 73A, but exploded;

FIG. 74A is a partial cutaway perspective view of a portion of the second actuator of FIG. 72, at a configuration corresponding to the untilted/unpivoted configuration of FIG. 6, illustrating a torsion spring connected to an actuator shaft thereby providing a counterbalance to the cover of FIG. 1, in accordance with the principles of the present disclosure;

FIG. 74B is the perspective view of FIG. 74A, but at a configuration corresponding to the pivoted/tilted configuration of FIG. 9, in accordance with the principles of the present disclosure;

FIG. 75 is a perspective view of a mount of the second actuator of FIG. 72; and FIG. 76 is a perspective view of the actuator shaft of FIG. 74A.

### DETAILED DESCRIPTION

Various embodiments will be described in detail with reference to the drawings, wherein like reference numerals represent like parts and assemblies throughout the several views. It is to be understood that this disclosure is not limited to the particular methodology and examples described herein and as such may vary. It is also to be understood that the terminology used herein is for the purpose of describing particular embodiments only and is not intended to limit the scope of the present disclosure or the appended claims.

As used herein and in the appended claims, the singular forms “a”, “an”, and “the” include plural reference unless the context clearly indicates otherwise.

Unless defined otherwise, all technical and scientific terms used herein have the same meaning as commonly understood to one of ordinary skill in the art to which this disclosure belongs.

In the embodiments illustrated at the figures, a box 150 (i.e., a bed) of a pickup truck 100 is generally covered and uncovered by a retractable cover arrangement. According to the principles of the present disclosure, the cover arrangement may further be adapted to other applications (e.g., retractable/convertible roofs, doors, overhead doors, access panels, etc.), other vehicles (e.g., trucks, RVs, vans, busses, etc.), and/or other pickup trucks, in general. Other pickup trucks may include Tesla's 2024 Cybertruck® and a pickup truck depicted at U.S. Pat. No. 12,083,875 B2, a pick-up truck depicted at U.S. Pat. No. 6,234,560, and Chevrolet's 2024 and 2025 Silverado® EV (see https://www.chevrolet.com/electric/silverado-ev).

The apparatuses described herein and illustrated at the figures are typically symmetric about a vertical longitudinal center plane of the pickup truck 100 (i.e., a vehicle), when installed. The passenger's (right) side components are typically described with the understanding that the driver's (left) side components are a mirror image. Thus, North America's typical vehicle convention is adopted for illustration purposes herein (vs. the British's). However, the apparatuses described and illustrated herein are suited, compatible, and/or adaptable for use with vehicles using either convention. Callouts referring to such pairs of components, parts, assemblies, etc. may have a last character of “P” when corresponding to the passenger's (right) side and may have a last character of “D” when corresponding to the driver's (left) side. Similar callouts without a last character of “P” or “D” may be referring to components that are generic, may correspond to both sides, may be used on both sides, and/or may extend to both sides, etc.

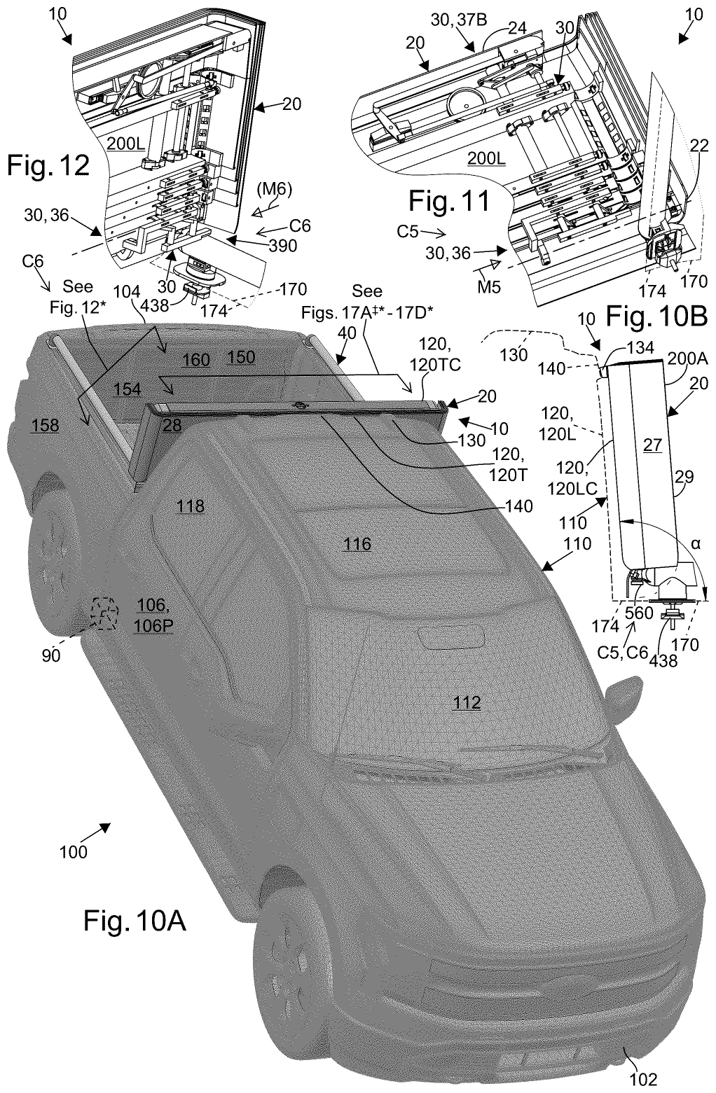

As depicted, the pickup truck 100 longitudinally extends between a front end 102 and a rear end 104 and transversely extends between a driver's side 106, 106D and a passenger's side 106, 106P. The box 150 includes an end gate 160 generally adjacent the rear end 104, a driver's side 158, 158D generally adjacent the side 106D, and a passenger's side 158, 158P generally adjacent the side 106P. The end gate 160 may move between a closed position (as shown) and an open position. When the end gate 160 is at the closed position, it may define a rear end 154 of the box 150, and when the end gate 160 is at the open position, it may extend a bottom 156 of the box 150. A front end 152 of the box 150 is generally adjacent a rear end 114 of a cab 110 (i.e., a cabin) of the pickup truck 100. The depicted cab 110 generally extends transversely between sides 118 adjacent the corresponding sides 106, extends vertically up to a roof 116, and extends longitudinally between a front end 112 and the rear end 114 with a rear window 114W at the rear end 114. The cab 110 is generally positioned between the front end 152 of the box 150 and the front end 102. As shown at FIGS. 10A & 10B, the cab 110 defines contours 120 including transverse contours 120T and longitudinal contours 120L. The depicted embodiment of the pickup truck 100 has a pair of rearward viewing cameras 130 mounted on the roof 116 and a center stop light 140 mounted at the rear end 114 adjacent the roof 116.

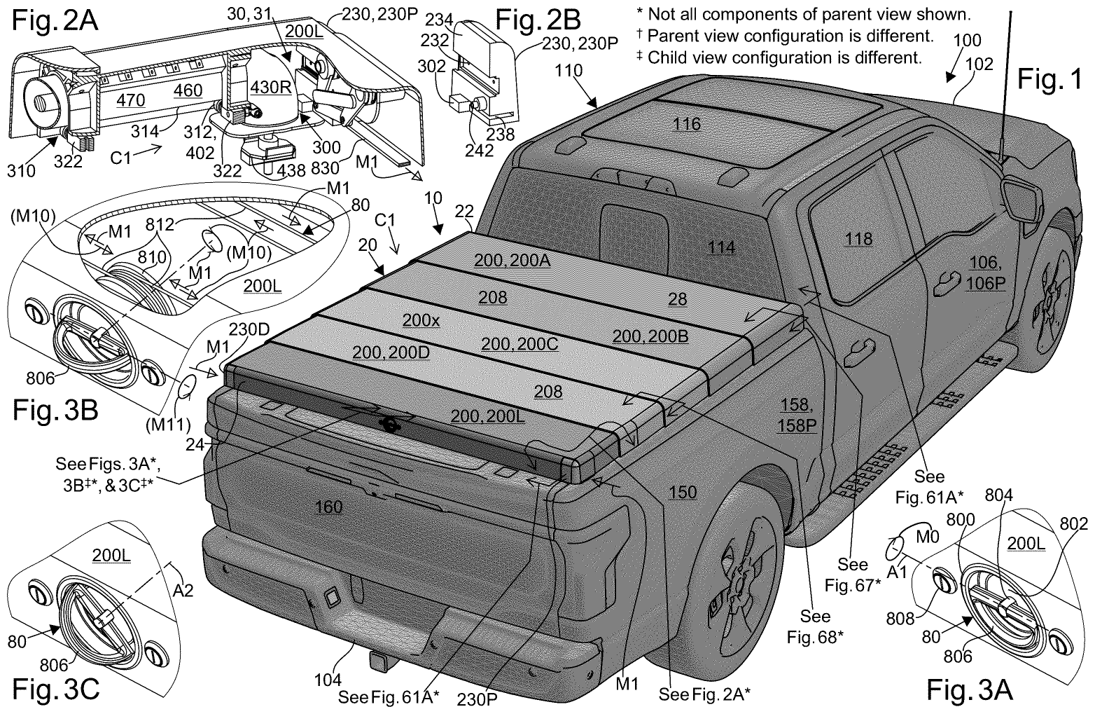

As illustrated at FIGS. 9, 14, & 16, the sides 158, the front end 152, and the end gate 160 generally extend upwardly to respective tops 170, 170D, 170P, 170F, and 170E, and the tops 170 generally lay at a horizontal plane. As shown at FIG. 1B of U.S. Pat. No. 12,083,875, top edges of a bed/box of other pickup trucks may generally lay at an angled plane. As illustrated at U.S. Pat. No. 6,234,560 and at the above-mentioned Silverado® EV literature, boxes/beds of other pickup trucks may generally extend (e.g., by conversion) into a corresponding cab and/or have multi-angle tops.

According to the principles of the present disclosure, an example retractable cover arrangement 10 (i.e., a cover arrangement, a cover, etc.) includes a retractable cover assembly 20 (i.e., a cover assembly, etc.) for covering and uncovering the box 150 (e.g., for covering and uncovering an opening of the box 150 with the tops 170 at a perimeter of the opening) of the pickup truck 100. The cover assembly 20 may thereby at least partially cover and uncover an interior 180 of the box 150. In certain embodiments, the cover arrangement 10 may further include a keeper group 30 that may selectively constrain (i.e., retain, attach, configure, etc.) the cover assembly 20. In certain embodiments, the cover arrangement 10 may further include a rail/track set 40. In certain embodiments, the cover assembly 20 may move along the rail/track set 40 and thereby at least partially cover and uncover the interior 180. In certain embodiments, the cover arrangement 10 may further include a pivotal set 50. In certain embodiments, the cover assembly 20 may be rotated (i.e., tilted, pivoted, etc.) by and/or about the pivotal set 50 and thereby at least partially cover and uncover the interior 180. In certain embodiments, the cover arrangement 10 may further include a mounting group 60. In certain embodiments, the mounting group 60 may secure the rail/track set 40 to the pickup truck 100 (e.g., via the box 150). In certain embodiments, the mounting group 60 may secure the pivotal set 50 to the pickup truck 100 (e.g., via the box 150 and/or via the rail/track set 40). In certain embodiments, the cover arrangement 10 may further include a structural group 70. In certain embodiments, the structural group 70 includes members that may reinforce, guide, constrain, support, etc. the cover assembly 20 and/or the rail/track set 40. In certain embodiments, the structural group 70 may include members that are integrated with the cover assembly 20 and/or the rail/track set 40. In certain embodiments, the cover arrangement 10 may further include an actuator group 80. In certain embodiments, the cover arrangement 10 may further include a control system 90.

The actuator group 80 may provide, transform, guide, etc. various movements to the cover arrangement 10. In certain embodiments, the actuator group 80 may include one or more powered actuators (e.g., electrically, pneumatically, hydraulically, etc.). In certain embodiments, the actuator group 80 may include one or more manual actuators (e.g., handles, cranks, pushing/pulling surfaces, etc.) In certain embodiments, the actuator group 80 may include one or more stored energy assisted actuators (e.g., spring driven actuators, gravity driven actuators, etc.).

The control system 90 may include wiring harness(es) 92, switch(es), sensor(s), latch(es), an app (e.g., a phone app), remote fob(s), human (i.e., user) interface(s), Bluetooth® interface(s), Wi-Fi interface(s), etc. The control system 90 may interface with and/or control actuator(s) of the actuator group 80. As illustrated at FIG. 10A, at least portions of the control system 90 may be remotely located on the pickup truck 100 (e.g., below the box 150). Passage(s) 94 may be provided to route the wiring harness(es) 92 and thereby facilitate remote mounting of at least portions of the control system 90. The wiring harness(es) 92 may be routed via stake pockets 176 (i.e., stake holes) of the box 150 of the pickup truck 100.

To illustrate and/or describe certain principles of the present disclosure, especially as depicted in the example embodiments shown at the figures, six example configurations have been correspondingly labeled C1, C2, C3, C4, C5, & C6. Other unlabeled configurations: may be illustrated at the figures, may be described herein but not necessarily illustrated at the figures, and/or will become apparent to one of ordinary skill in the art in view of the present disclosure. The labeling of the configurations does not necessarily indicate any required use or order of use, and configurations between or adjacent the labeled configurations may be used. Explanations and/or descriptions of configurations may reference one or more of an assembly/arrangement that includes the pickup truck 100, a top-level assembly/arrangement, an assembly/arrangement, a subassembly, a part/component, a feature, a setting, a characteristic, etc. Although described with respect to these groupings, other items not within the grouping may be included by and/or configured by the particular configuration, including parent assemblies/arrangements and/or subordinate assemblies, arrangements, components, parts, features, settings, characteristics, etc.

The cover arrangement 10 (i.e., retractable cover) may be supplied with the pickup truck 100 (e.g., as an option, an accessory, a feature on a certain model, etc.) from the factory and/or the dealer, as an aftermarket component (owner installed and/or shop installed), etc. Certain features of the cover arrangement 10 may be integrated into the pickup truck 100 (e.g., tracks, mounts, wiring harnesses, rails, etc.). The cover arrangement 10 may be supplied as a kit, e.g., to convert a coverless pickup truck and/or a previously covered pickup truck to, e.g., the pickup truck 100.

As shown at FIGS. 1, 6, 45, & 47, the retractable cover assembly 20 generally extends longitudinally between a front end 22 (e.g., a first end) and a rear end 24 (e.g., a second end), generally extends transversely between a first side 26 (e.g., a right side, a passenger's side) and a second side 27 (e.g., a left side, a driver's side), and generally extends between a third side 28 (e.g., a top side) and a fourth side 29 (e.g., a bottom side).

In the depicted embodiment, the retractable cover assembly 20 includes a set of panels 200. As illustrated at FIGS. 1, 55A, 56, 57, 58A, & 59A, the panels 200 may each generally extend longitudinally between a front end 202 (e.g., a first end) and a rear end 204 (e.g., a second end), transversely between a first side 206 (e.g., a right side, a passenger's side) and a second side 207 (e.g., a left side, a driver's side), and further extend between a third side 208 (e.g., a top side) and a fourth side 209 (e.g., a bottom side). As depicted, the panels 200 may each include a sheet metal component 210 that forms a skin. The panels 200 may each include one or more curved (radiused) corners 218 between, e.g., the top side 208 and the sides 206 and 207.

The panels 200 may include a first panel 200A and a last panel 200L. In certain embodiments with more than two panels 200, one or more intermediate panels 200x may be between the first panel 200A and the last panel 200L. The embodiment depicted at the figures includes five of the panels 200 and thus includes three intermediate panels 200B, 200C, 200D. Other embodiments may include fewer than or more than three of the intermediate panels 200x.

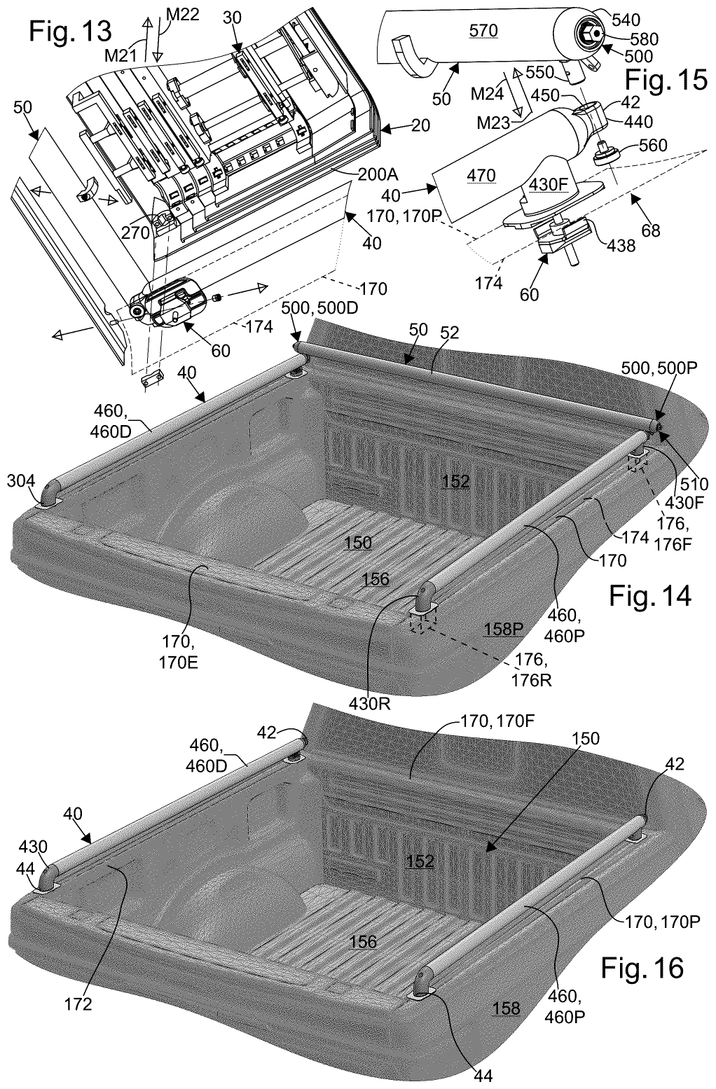

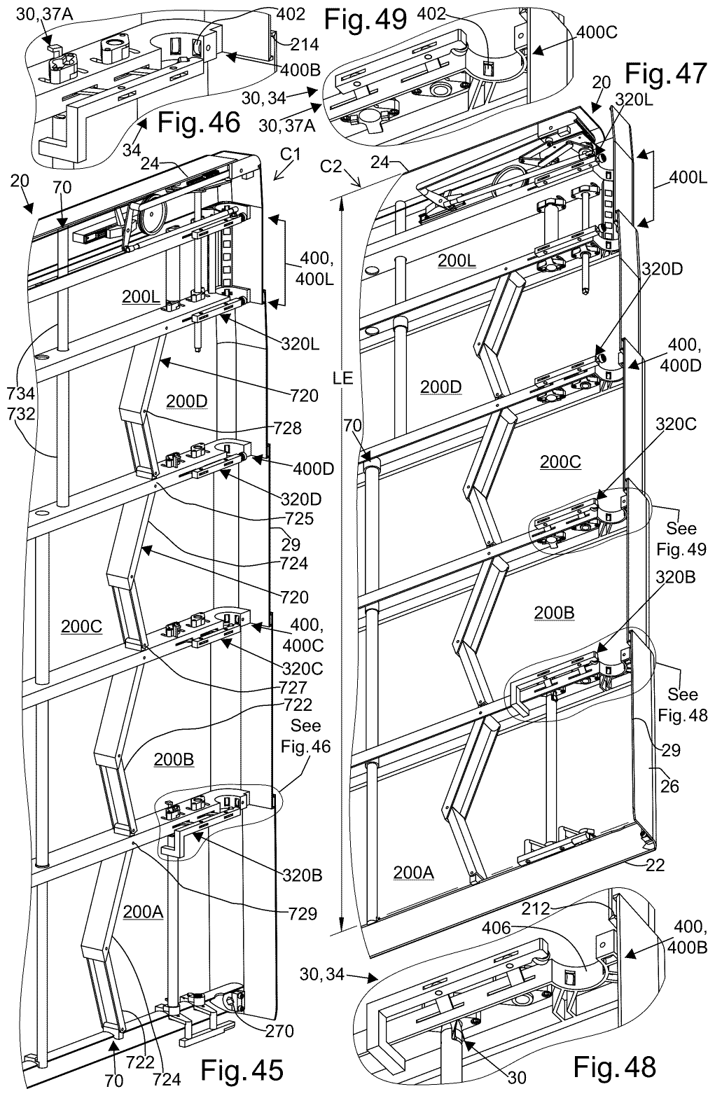

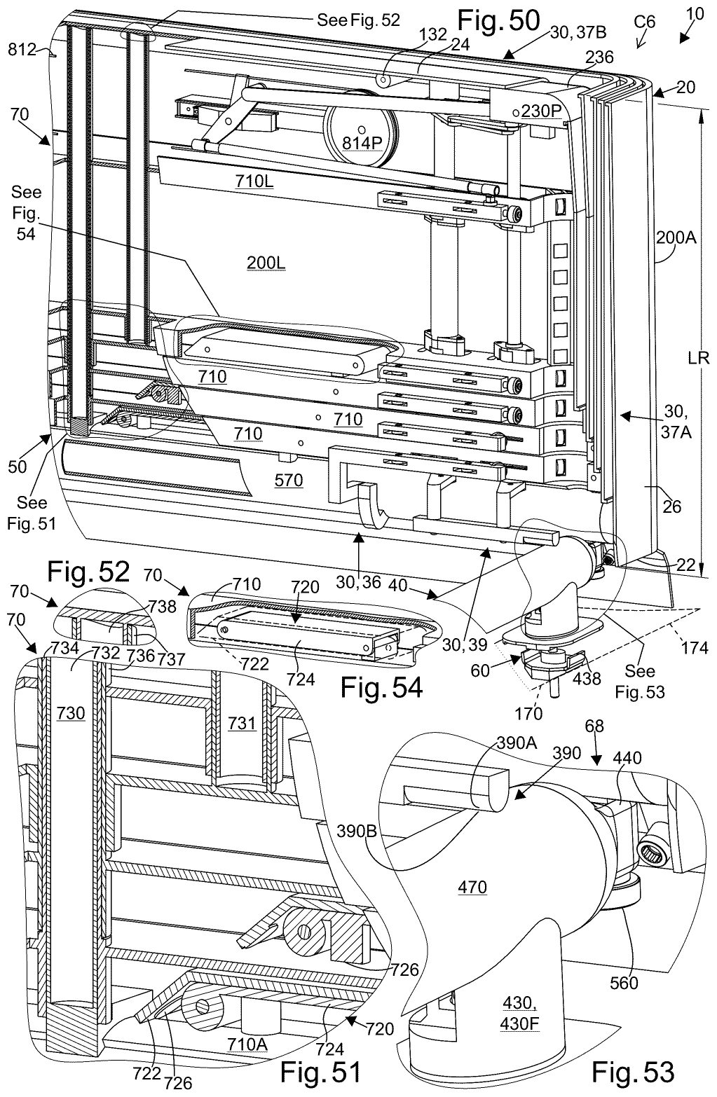

As depicted at FIGS. 13, 46, 48, 50, 62A, & 62B, the panels 200 may at least partially nest together when retracted (e.g., when at configurations C3, C4, C5, & C6), and adjacent ends of the panels 200 may at least partially nest together when extended (e.g., when at configurations C1 & C2). As depicted at FIGS. 1, 6, 61A, & 61B, the retractable cover assembly 20 is telescoping and may thereby vary its length from an extended length LE (e.g., when at configurations C1 & C2, as shown at FIGS. 45 & 47) to a retracted length LR (e.g., when at configurations C3, C4, C5, & C6, as shown at, e.g., FIG. 50).

As depicted at FIGS. 46, 48, & 62B, the panels 200B, 200C, 200D, 200x, & 200L include a front lip 212, and the panels 200A, 200B, 200C, 200D, & 200x include a rear lip 214. The front and rear lips 212, 214 may keep (i.e., retain) an inter-panel member 215 between adjacent panels 200. The inter-panel member 215 may be a seal, a bushing (e.g., load transferring), a detent (e.g., magnetic), an anti-rattle member, etc. or combinations thereof. The detents (e.g., within and/or adjacent the members 215) may be varied in strength between pairs of adjacent panels 200 and thereby predetermine an opening sequence (i.e., an extension sequence) and/or a closing sequence (i.e., a retraction sequence) of the retractable cover assembly 20. The front and rear lips 212, 214 may keep adjacent panels 200 from overextending (see FIG. 62A) and thereby collectively keep the retractable cover assembly 20 from overextending (i.e., keep the extended length LE from being exceeded).

As shown at FIGS. 59A-60C, the last panel 200L may further include a wall 216 (e.g., a rear wall) at the rear end 204, and another curved (radiused) corner 218 may be included between the top side 208 and the rear wall 216. The last panel 200L may include a pair of cut-outs 220 (e.g., through the rear wall 216, the side walls 206 and/or 207, and/or into the corner(s) 218). The cut-outs 220 (i.e., passages) may accommodate the rail/track set 40 when the cover assembly 20 at least partially uncovers the interior 180 of the box 150 and/or would otherwise interfere with the rail/track set 40. The last panel 200L may further include a pair of mounting plates 222 (see FIG. 60B) that, together with the wall 216, form a pair of slide channels 224.

In certain embodiments, the cover assembly 20 further includes one or more covers 230. The covers 230 may include an interior surface 234 (see FIG. 2B) and/or an exterior surface 236 (see FIG. 50). In the depicted embodiment, the cover assembly 20 includes a pair of covers 230, 230P, 230D (i.e., rail passage covers) that are adapted to open (e.g., when at configurations C2, C3, C4, & C5) to, e.g., accommodate the rail/track set 40 when the cover assembly 20 at least partially uncovers the interior 180 of the box 150 and/or would otherwise interfere with the rail/track set 40 and are adapted to close (e.g., when at configurations C1 & C6) to cover the interior 180 when the cover assembly 20 covers the interior 180 (e.g., when at configuration C1, as illustrated at FIG. 1). In the depicted embodiment, the pair of covers 230, 230P, 230D respectively cover the pair of cut-outs 220 (e.g., when at configurations C1 & C6). In certain embodiments, the covers 230 may close for aesthetic and/or other reasons (e.g., when at configuration C6, as illustrated at FIG. 50).

In other embodiments, the rear wall 216 may hinge out of the way to accommodate the rail/track set 40 (e.g., when the rear end 24 of the retractable cover assembly 20 is over and/or would otherwise interfere with the rail/track set 40) and thereby avoid the need for the cut-outs 220 and/or the covers 230, which may thereby be unused. In yet other embodiments, the rail/track set 40 may extend rearwardly and thereby fill or partially fill the cut-outs 220 when the retractable cover assembly 20 is extended (e.g., when at configurations C1 & C2). In still other embodiments, such covers may not be included. In yet other embodiments, deformable covers may cover or partially cover the cut-outs 220 when the retractable cover assembly 20 is extended (e.g., when at configurations C1 & C2). The deformable covers may be mounted, e.g., on the rear wall 216.

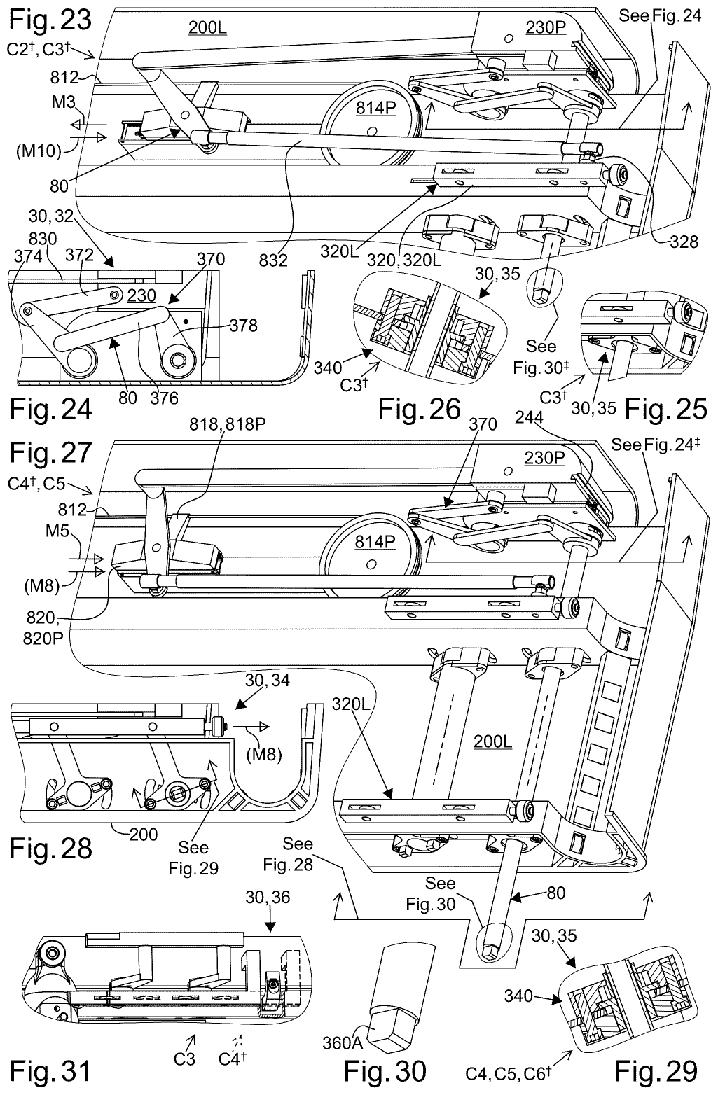

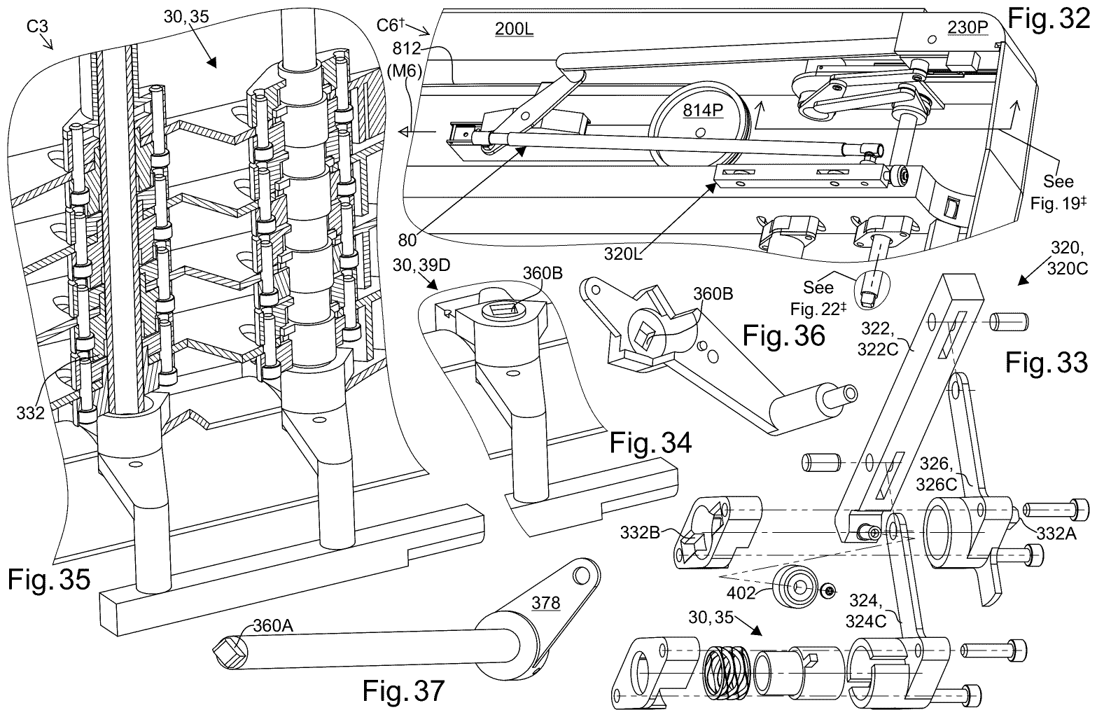

The pair of covers 230, 230P, 230D may slide back and forth within the pair of slide channels 224 (see FIGS. 18, 23, & 60B) to correspondingly cover and uncover the pair of cut-outs 220. As illustrated at FIG. 60B, a stop 248 may be included on the last panel 200L to stop the cover 230 upon reaching an open position (e.g., when at configurations C2, C3, C4, & C5). As illustrated at FIGS. 27 & 60C, a securement feature 244 (e.g. a slot, a groove, etc.) may be included on the cover 230 and a securement feature 246 (e.g., a tongue) may be included on the last panel 200L. When the cover 230 reaches a closed position (e.g., when at configurations C1 & C6), the groove 244 engages the tongue 246 and thereby may secure, align, and/or stop the covers 230. As shown at FIG. 19, a slide 228 may slidingly connect each of the covers 230 to the last panel 200L. The slide 228 may attach to the last panel 200L at slide mounts 226 (see FIG. 60B) and may attach to the cover 230 at slide mounts 232 (see FIG. 2B).

As depicted, the retractable cover assembly 20 may pivot and/or tilt (e.g., when at configurations C5 & C6), and pivoting (i.e., tilting) may further uncover and recover the interior 180 of the box 150. As depicted at FIGS. 10A & 10B, the cover assembly 20 may pivot such that the longitudinal contours 120L and/or the transverse contours 120T of the cab 110 are generally parallel (i.e., approximately parallel, generally aligned, etc.) with corresponding longitudinal contours 120LC and/or transverse contours 120TC of the cover assembly 20. A bumper 134 may position the cover assembly 20 at such a generally aligned and/or parallel orientation when pivoted and/or prevent collision of the cover assembly 20 with the cab 110. The bumper 134 may be integrated with and/or mounted to the center stop light 140.

As illustrated at FIG. 9, in embodiments where the center stop light 140 is covered or partially covered by the retractable cover assembly 20 (e.g., when at configurations C5 & C6), a cover mounted stop light 142 (e.g., a cover mounted rear center stop light) may be provided and may be orientated and/or activated when at corresponding configurations.

As illustrated at FIG. 10B, the pair of rearward viewing cameras 130 mounted on the roof 116 of the pickup truck 100 may have view field(s) that are not affected or are minimally affected by the retractable cover assembly 20 (e.g., when at configurations C5 & C6). However, as illustrated at FIG. 50, at least one camera 132 may be provided and may be orientated and/or activated when at corresponding configurations C5 & C6. The camera(s) 132 may substitute (e.g., automatically substitute) for the camera(s) 130 in embodiments where the camera(s) 130 are covered or partially covered by the retractable cover assembly 20 (e.g., when at configurations C5 & C6).

As depicted at FIGS. 1 & 6, the top sides 208 of the panels 200 may generally lay at horizontal planes and/or generally lay parallel to the tops 170 of the box 150 when the cover assembly 20 is at an unpivoted configuration (e.g., when at configurations C1, C2, C3, & C4). In other embodiments, the top sides 208 may generally lay coplanar or nearly coplanar with the tops 170 of the box 150 when the cover assembly 20 is at an unpivoted configuration. When used with pickup trucks with boxes/beds with non-horizontal tops (e.g., the above-mentioned Cybertruck®), the panels 200 may generally lay parallel and/or coplanar with these non-horizontal tops (e.g., upper top edges) when at, e.g., an unpivoted configuration. When used with pickup trucks with boxes/beds with non-horizontal tops that locally blend with a roof of a corresponding cab (e.g., the above-mentioned Cybertruck®), the retractable cover assembly 20 may be pivoted such that the longitudinal contours 120LC and/or the transverse contours 120TC of the cover assembly 20 are generally parallel (i.e., generally aligned, approximately parallel, etc.) with corresponding longitudinal contours and/or transverse contours of the corresponding cab roof.

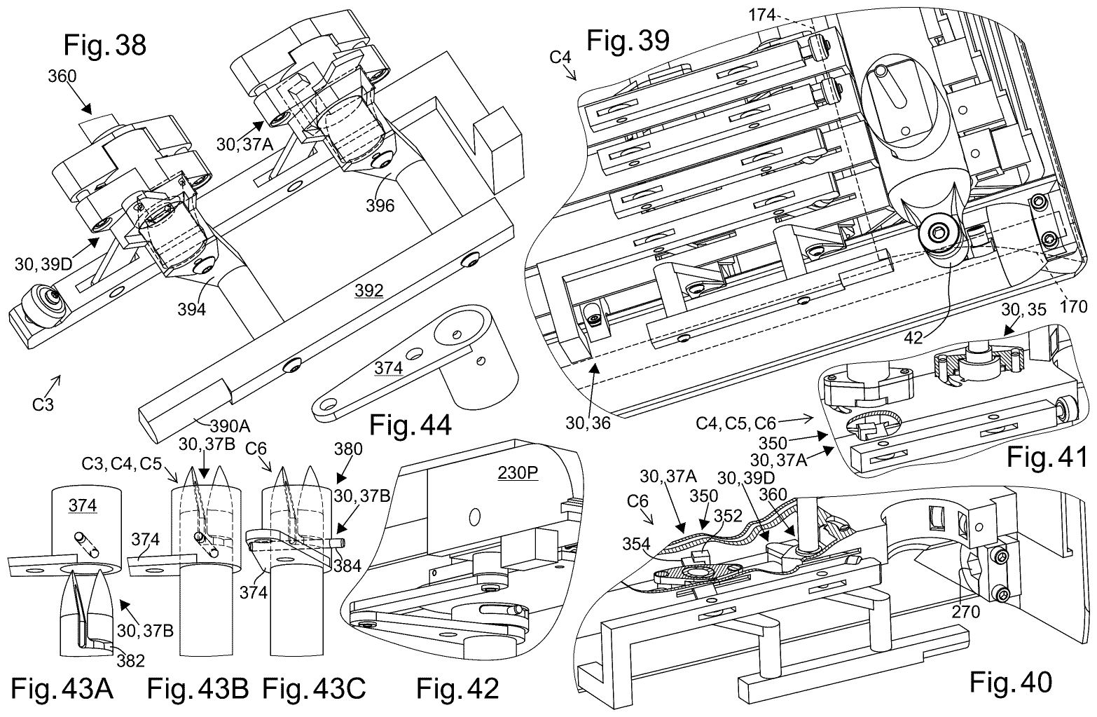

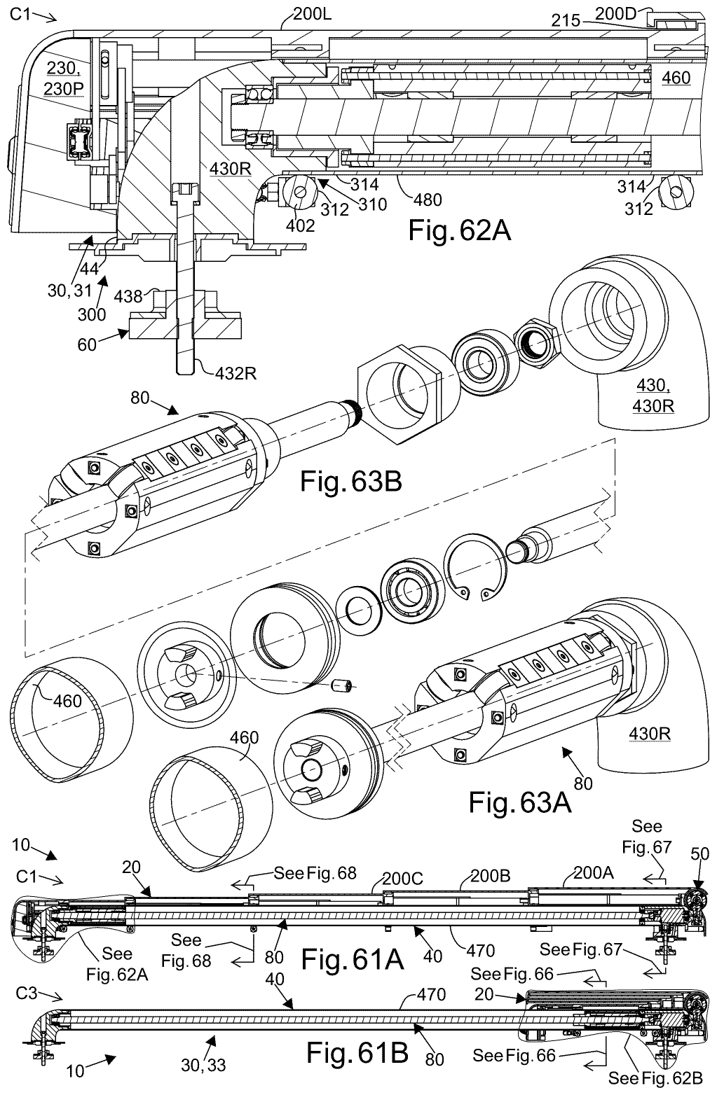

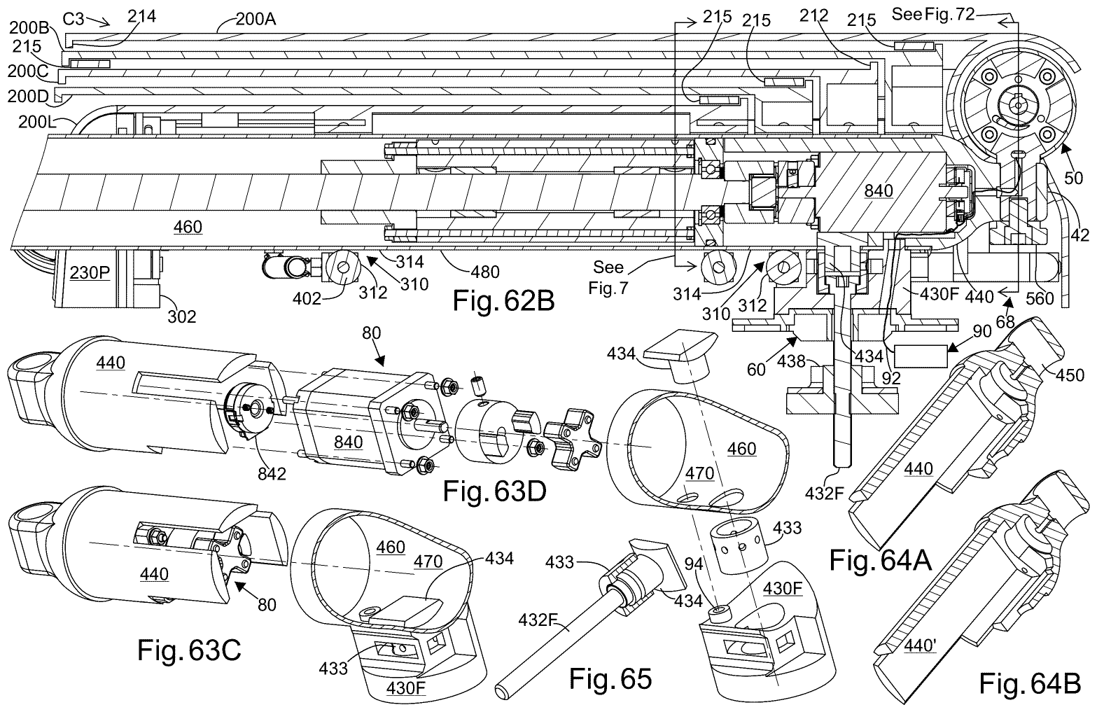

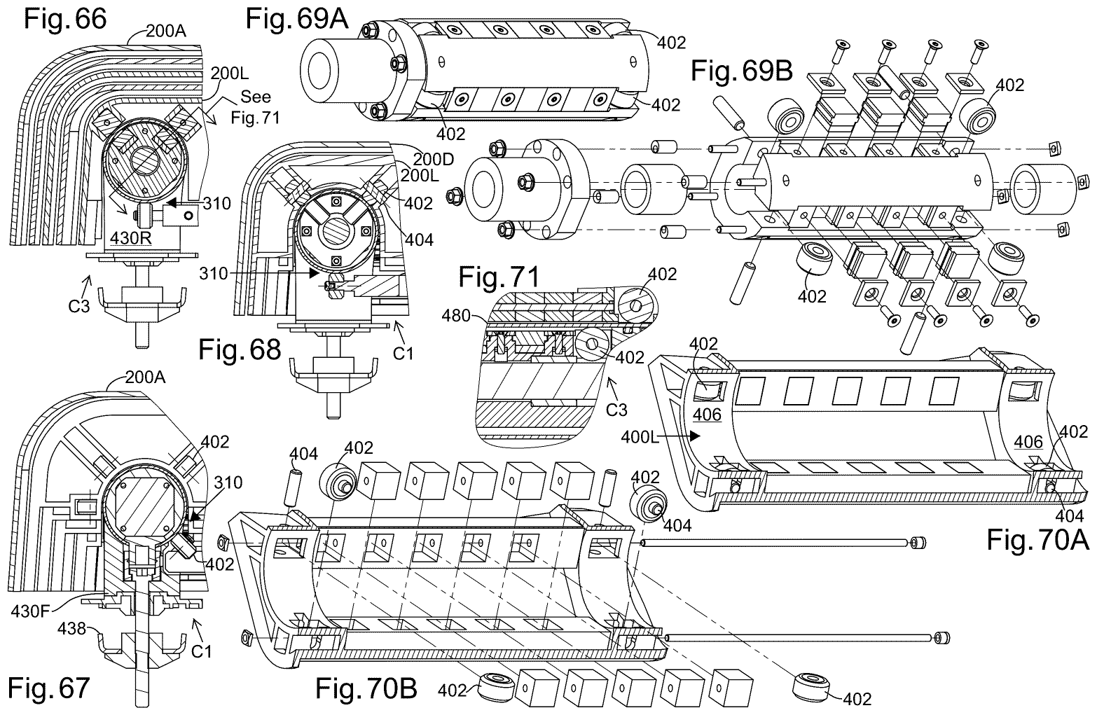

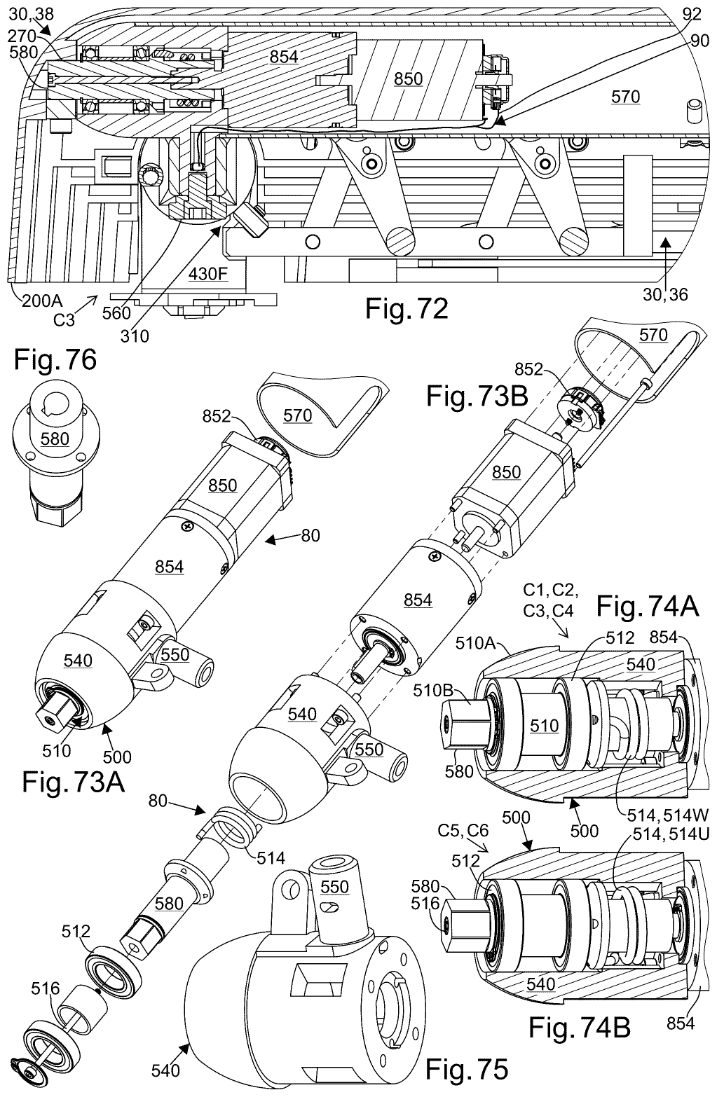

In the depicted example embodiment, the keeper group 30 includes:
an extension keeper group 31 (i.e., an extension lock group, etc.) that may selectively keep (i.e., retain, hold, lock, etc.) and/or release the retractable cover assembly 20 at or near the extended length LE (see FIGS. 2A & 62A (kept) & 5 & 47 (released));
a rail passage cover keeper group 32 (i.e., a keeper group) that may selectively open (see FIG. 24) and/or close (see FIG. 19) the pair of covers 230, 230P, 230D;
an extension-retraction keeper group 33 (i.e., a keeper group) that may selectively keep (i.e., retain, hold, lock, etc.) and/or release the retractable cover assembly 20 (e.g., when unpivoted) at or near the extended length LE (see FIG. 47), at or near the retracted length LR (see FIG. 50), and/or at any length between the extended length LE and the retracted length LR (see FIG. 61B);
a panel to track retainer group 34 (i.e., a retainer group) that may selectively retain (i.e., keep, hold, lock, etc.), as illustrated at FIGS. 7 & 20, and/or release, as illustrated at FIGS. 8 & 28, one or more panels 200 and the rail/track set 40 (e.g., via a rail 460 of the rail/track set 40) to and/or from each other;
a panel-track retainer (retaining) keeper group 35 that may selectively keep (i.e., retain, hold, lock, etc.), as illustrated at FIGS. 18 & 21, and/or release, as illustrated at FIGS. 25, 26, 29, 35, & 41, the panel to track retainer group 34 and thereby selectively keep the one or more panels 200 and the rail/track set 40 retained to each other (e.g., while the retractable cover assembly 20 is not at or near the retracted length LR);
a panel-track retainer (released) keeper group 36 that may selectively keep (i.e., retain, hold, lock, etc.), as illustrated at FIGS. 11, 12, & 50, and/or release, as illustrated at FIGS. 31, 39, & 72, the panel to track retainer group 34 and thereby selectively keep the one or more panels 200 and the rail/track set 40 released from each other (e.g., while the retractable cover assembly 20 is rotated (i.e., pivoted) and/or upon being unpivoted);
a retraction keeper group 37A (i.e., a retraction lock group, a retainer group, etc.) that may selectively keep (i.e., retain, hold, lock, etc.), as illustrated at FIGS. 40, 41, & 50, and/or release, as illustrated at FIGS. 38, 46, & 49, the retractable cover assembly 20 at or near the retracted length LR (see FIG. 50);
a retraction keeper group 37B (i.e., a retraction lock group, a retainer group, etc.) that may selectively keep (i.e., retain, hold, lock, etc.), as illustrated at FIGS. 43C & 50, and/or release, as illustrated at FIGS. 11, 43A, & 43B, the retractable cover assembly 20 at or near the retracted length LR (see FIG. 50);
a pivot-unpivot keeper group 38 (see FIG. 72) that may selectively keep (i.e., retain, hold, lock, etc.) and/or release the retractable cover assembly 20 at or near a pivoted position (see FIGS. 9-12 & 50), at or near an unpivoted position (see FIGS. 1, 6, 61A-62B, & 72), at any position between the pivoted position and the unpivoted position, at or near an angle a (see FIG. 10B), at or near a horizontal position (see FIG. 62B), and/or at any angle in an angular range a (see FIG. 10B);
a pivot keeper group 39 (see FIGS. 50 & 53) that may selectively keep (i.e., retain, hold, lock, etc.) and/or release the retractable cover assembly 20 at or near the pivoted position (see FIGS. 9-12 & 50) and/or at or near the angle a (see FIG. 10B); and
a pivot keeper detent group 39D that may selectively keep (i.e., retain, hold, lock, etc.) the pivot keeper group 39 at a pivot keeping configuration, as illustrated at FIGS. 12, 40, 50, & 53, and/or at a pivot releasing configuration, as illustrated at FIGS. 9, 11, 13, 31, 34, 35, 38, 39, 45, 47, & 72, and thereby selectively keep the retractable cover assembly 20 at or near the pivoted position and/or selectively release the retractable cover assembly 20 from the pivoted position.

In the depicted embodiment, the keeper group 30 may include various mechanisms that may drive multiple sub-groups and thereby interlink certain of the sub-groups (e.g., mechanically and/or electrically) and/or certain of their movements. In this way, multiple user control inputs may be consolidated to a same user interface (e.g., an actuating handle assembly 800). In other embodiments, this interlinking may be rearranged, including eliminating certain sub-groups, adding additional sub-groups, combining certain sub-groups, and/or separating certain sub-groups from each other. In certain embodiments, some or all of the interlinking may be electrically implemented. In certain embodiments, some or all of the interlinking may be programmable, may be changed on-the-fly, etc. In the depicted example embodiment, relationships between the six example labeled configurations, C1, C2, C3, C4, C5, & C6, and the above-mentioned configurations of the sub-groups of the keeper group 30 include:
the extension keeper sub-group 31 is configured “kept” at configurations C1 & C6 and is configured “released” at configurations C2, C3, C4, & C5;
the rail passage cover keeper sub-group 32 is configured “opened” at configurations C2, C3, C4, & C5 and is configured “closed” at configurations C1 & C6;
the extension-retraction keeper sub-group 33 is configured “extended” at configurations C1 & C2 and configured “retracted” at configurations C3, C4, C5, & C6;
the panel to track retainer sub-group 34 is configured “retained” at configurations C1, C2, & C3 and is configured “released” at configurations C4, C5, & C6;
the panel-track retainer (retaining) keeper sub-group 35 is configured “kept” at configurations C1 & C2 and is configured “released” at configurations C3, C4, C5, & C6;
the panel-track retainer (released) keeper sub-group 36 is configured “kept” at configurations C5 & C6 and is configured “released” at configurations C1, C2, C3, & C4;
the retraction keeper sub-group 37A is configured “kept” at configurations C4, C5, & C6 and is configured “released” at configurations C1, C2, & C3;
the retraction keeper sub-group 37B is configured “kept” at configuration C6 and is configured “released” at configurations C1, C2, C3, C4, & C5;
the pivot-unpivot keeper sub-group 38 is configured “unpivoted” at configurations C1, C2, C3, & C4 and is configured “pivoted” at configurations C5 & C6;
the pivot keeper sub-group 39 is configured “kept” at configuration C6 and is configured “released” at configurations C1, C2, C3, C4, & C5; and
the pivot keeper detent sub-group 39D is configured “kept” at configuration C6 and is configured “released” at configurations C1, C2, C3, C4, & C5.

In the depicted embodiment, the rail/track set 40 is adapted for fixedly mounting (and/or unmounting) to (and/or from) the box 150 of the pickup truck 100 (see FIGS. 14-16). In the depicted embodiment, the rail/track set 40 is a rail set with tracks 480 (see FIGS. 62A, 62B, & 71) included on a pair of rails 460, 460D, 460P (e.g., on tubes 470). In other embodiments, a track set may replace the rail/track set 40 (e.g., the track set may include tracks without rails). In certain embodiments, the rail/track set 40 and/or the track set may be included and/or incorporated into the side(s) 158, 158D, 158P of the box 150, e.g., on, above, and/or below flange(s) 172 (see FIG. 16) of the box 150 and/or on, above, and/or below the tops 170, 170D, 170P (see FIGS. 9 & 16) of the box 150. In certain embodiments, the rail/track set 40 and/or the track set may be included on or attached to cover(s)/mounting bracket(s) 174 that are coextensive or partially coextensive with the top(s) 170, 170D, 170P. In certain embodiments, the rail/track set 40 and/or the track set may not necessarily have continuous rails and/or continuous tracks.

In the depicted embodiment, two pairs of rail mounts 430 (i.e., mounts) fixedly mount the rail/track set 40 to two pairs of stake pockets 176 (i.e., stake holes) of the box 150. Such stake pockets 176 typically extend to and/or through the tops 170, 170D, 170P of the corresponding sides 158, 158D, 158P of the box 150. (Certain pickup trucks, such as Ford's 2022 F-150 with 51/2 foot box, may have removable cap(s) covering opening(s) of the stake pocket(s) 176 and/or may have stake pocket(s) 176 that are hidden stake pocket(s) that can be revealed by cutting (e.g., a hole) through the top(s) 170. Removing such cap(s) and/or revealing such hidden stake pocket(s) may facilitate installing the mount(s) 430.) As shown at FIGS. 5, 14, & 15, a front rail mount 430F mounts to a front stake pocket 176F, and a rear rail mount 430R mounts to a rear stake pocket 176R and thereby attach the rail 460, 460P to the passenger's side 158P of the box 150. The rail 460, 460D may likewise be attached to the driver's side 158D of the box 150 with mounts 430 that may be, in part or in whole, mirrored versions (i.e., enantiomorphs) of those shown attached to the passenger's side 158P. In the depicted embodiment, each rail 460 is attached to and supported by two rail mounts 430. In other embodiments, more than two rail mounts 430 may be used per side 158. In still other embodiments, a single rail mount may at least partially longitudinally extend with each rail 460, 460D, 460P.

In the depicted embodiment, the mounting group 60 is adapted to directly attach the front rail mounts 430F to the front stake pockets 176F and the rear rail mounts 430R to the rear stake pockets 176R (on the passenger's side 158P and on the driver's side 158D of the box 150, i.e., 4x). In other embodiments, an alternate mounting group may be adapted to indirectly attach the front rail mounts 430F and/or the rear rail mounts 430R to the front stake pockets 176F and/or the rear stake pockets 176R (on the passenger's side 158P and on the driver's side 158D of the box 150). For example, if a spacing between the front stake pockets 176F and the rear stake pockets 176R does not match a desired and/or a needed spacing, the cover(s)/mounting bracket(s) 174 may be used to adapt the spacing to the desired and/or the needed spacing. The cover(s)/mounting bracket(s)/adapter(s) 174 may thereby be used to offset (i.e., jog) the mounts 430F from the stake pockets 176F and/or the mounts 430R from the stake pockets 176R.

Such stake pockets 176 are typically structural components of the box 150 and/or the pickup truck 100 and typically are substantially stronger, stiffer, etc. than attachments points (e.g., sheet metal tabs) connected to by clamps of certain conventional covers. Thus, the stake pockets 176, and their attachment to the rail/track set 40, provide a strong and/or stiff foundation for the structural group 70 and thereby for the retractable cover arrangement 10, as will be described in additional detail, below.

The rail/track set 40 extends between a front end 42 (i.e., a first end) and a rear end 44 (i.e., a second end). As shown at FIG. 62A, the rear rail mount 430R is fixedly connected to a rear end of the rail 460 and defines the rear end 44 of the rail/track set 40. As shown at FIG. 62B, the front rail mount 430F is fixedly connected near a front end of the rail 460, and a mount housing 440 (also see FIG. 64A) is fixedly connected to the front end of the rail 460 and defines the front end 42 of the rail/track set 40. Alternatively, a mount housing 440′, illustrated at FIG. 64B, may be fixedly connected to the front end of the rail 460. Alternatively, the front rail mount 430F and the mount housing 440, 440′ may be integrated (i.e., merged together) with each other. The cover(s)/mounting bracket(s)/adapter(s) 174 may facilitate this merger by facilitating an offset between the mounts 430F from the stake pockets 176F.

As shown at FIG. 62A, a conventional socket head cap screw 432R may be used to secure the rear rail mount 430R (via a fastener hole) to the rear stake pocket 176R (see FIG. 14) of the box 150 via a first retainer 438 of the mounting group 60. As depicted, the fastener 432R is not hidden when viewing the rail mount 430R from typical operator viewpoints and further is conveniently accessible from at and/or near the top 170, 170D, 170P of the box 150. However, an orientation of the fastener 432R may be reversed, threads may be added to the fastener hole of the rail mount 430R, the fastener hole of the rail mount 430R may be changed into a blind hole (with a bottom opening), and a threaded hole of the retainer 438 may be changed into a smooth through hole, and thereby the fastener 432R may be hidden from the typical operator viewpoints and may provide enhanced security. (The stake pockets 176 are typically reachable from underneath the pickup truck 100 for the reversed installation of the fastener 432R, and/or other provisions may be made for the hidden installation of the fastener 432R, or the like.)

As shown at FIGS. 62B & 63C-65, a special socket head cap screw 432F with a shoulder and a seat, a spanner wrench nut 433 with an inner flange, and a saddle bolt 434 with a convex saddle may be used to secure the front rail mount 430F and the rail 460 to the front stake pocket 176F (see FIG. 14) of the box 150 via a second retainer 438 of the mounting group 60. Installation may include first installing the front rail mount 430F to the top 170, 170D, 170P of the box 150 by: a) slantingly inserting the retainer 438 into the stake pocket 176F, b) inserting the screw 432F through the nut 433 and seating the inner flange against the shoulder, c) inserting the screw 432F through a hole of the mount 430F, d) threading the screw 432F into the retainer 438 a few turns, and c) tightening the screw 432F until the seat is tight against the mount 430F and the retainer 438 is tight against an inside flange of the stake pocket 176, and thereby attaching the mount 430F to the top 170, 170D, 170P and to the stake pocket 176. Installation may secondly include attaching the rail 460 to the mount 430F and thereby to the top 170 and to the stake pocket 176 of the box 150 by: f) inserting the saddle bolt 434 through a mounting hole of the rail 460, g) mating the saddle against an inside surface of the rail 460, and h) tightening the nut 433 on threads of the saddle bolt 434 until the inner flange is tight against the shoulder and the rail 460 is tight against the mount 430F, and thereby attaching the rail 460 to the mount 430F. Upon installation, a gap may exist between a top of the screw 432F and a bottom of the saddle bolt 434.

As depicted at FIGS. 12 & 63C, the fastener 433 is not entirely hidden when viewing the rail mount 430F from a viewpoint inside the box 150 and further is conveniently accessible from at and/or near the top 170 of the box 150. However, an alternative mounting arrangement may hide mounting fasteners of the rails 460 from typical operator viewpoints and may provide enhanced security. For example, the fastener 432F may be replace by another of the fasteners 432R and reversed in orientation, threads may be added to the hole of the rail mount 430F, the hole of the rail mount 430F may be changed into a blind hole (with a bottom opening), and a threaded hole of the retainer 438 may be changed into a smooth through hole, and thereby the fastener 432R may be hidden from the typical viewpoints. (Certain of the preceding details also further describe the attachment of the rear rail mount 430R with the hidden fasteners.) Other provisions may be made for the hidden installation of the fastener 432R, 432F, or the like.

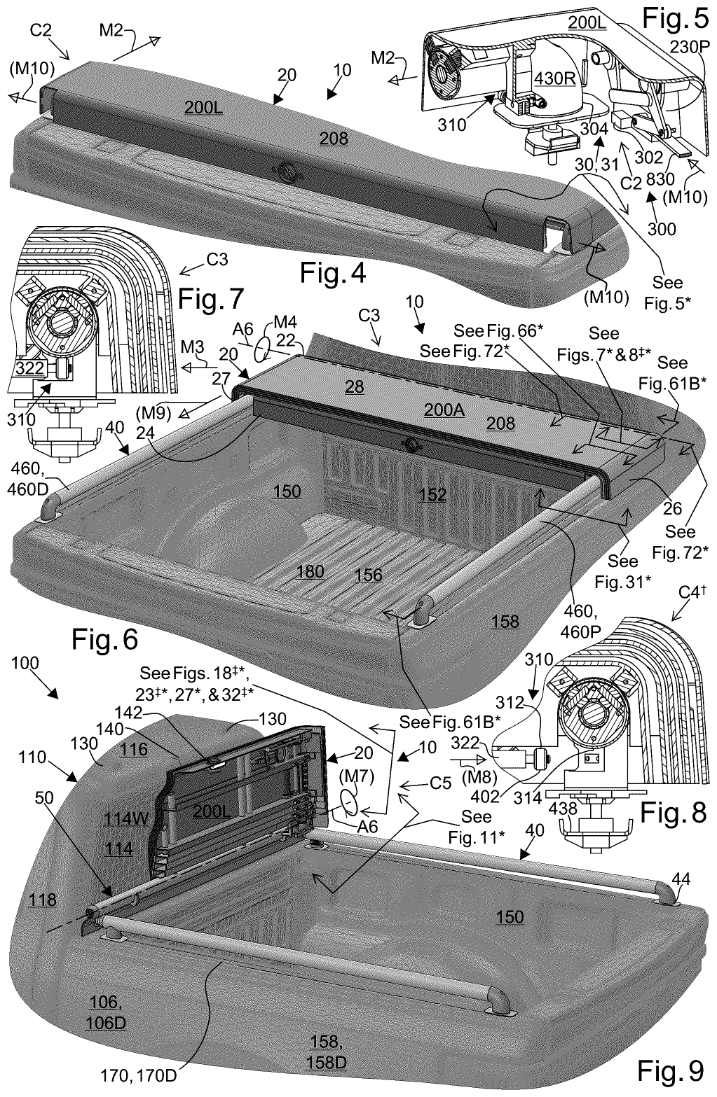

The rail/track set 40 may passively guide movement of and/or actively move (powered via the actuator group 80, as will be described in additional detail, below) at least one panel 200 of the retractable cover assembly 20 and thereby participate in at least partially covering and uncovering the interior 180 of the box 150 of the pickup truck 100. In the depicted embodiment, the last panel 200L may be moved along the rails 460, 460D, 460P and thereby move the intermediate panels 200B, 200C, 200D, 200x and thereby reconfigure the cover assembly 20 between the configurations C2 & C3 (see FIGS. 4 & 6). As mentioned above, detents may be used to predetermine the sequence of movement for the panels 200B, 200C, 200D, 200x when at least partially covering and/or uncovering the interior 180. In the depicted embodiment, the rail/track set 40 mounts the panels 200B, 200C, 200D, 200L, 200x to the box 150 and thereby to the pickup truck 100 via slide groups 400, 400B, 400C, 400D, 400L (i.e., slides) in conjunction with the panel to track retainer group 34 (see FIGS. 45-49), at least when at and between the configurations C2 & C3. In this way, the panels 200B, 200C, 200D, 200L, 200x are slidingly mounted to the box 150. In other embodiments, certain of the panels 200 may not necessarily be so mounted and/or may be partially mounted (e.g., the slide group 400C may be used without the corresponding retainer from the track retainer group 34, only the last slide group 400L may use the corresponding retainer from the track retainer group 34, etc.). In the depicted embodiment, the rail/track set 40 and the corresponding movements are linear. In other embodiments, the rail/track set 40 and the corresponding movements may be curvilinear and not necessarily linear.

In the depicted embodiment, the pivotal set 50 is adapted for fixedly mounting (and/or unmounting) to (and/or from) the box 150 of the pickup truck 100 (see FIGS. 13-16). As depicted, the pivotal set 50 mounts to the rail/track set 40 and thereby mounts to the box 150 and the pickup truck 100. In other embodiments, the pivotal set 50 may directly mount to the box 150, the cab 110, and/or other component(s) of the pickup truck 100. In other embodiments, the pivotal set 50 may be included and/or incorporated into the box 150, the cab 110, and/or other component(s) of the pickup truck 100.

In the depicted embodiment, the pivotal set 50 includes a pair of pivotal mounts 500, 500D, 500P connected together by a tube 570, and the pivotal mounts 500 each include a pivot joint 510 that may passively guide rotation and/or actively rotate (powered via the actuator group 80, as will be described in additional detail, below) the retractable cover assembly 20 about a fixed axis A6 (e.g., between configurations C4 & C5, as depicted at FIGS. 6 & 9).

In other embodiments, pivotal mounts may passively and/or actively rotate and translate the cover assembly 20 and thereby may passively and/or actively rotate the cover assembly 20 about a floating axis. The fixed axis A6 and/or the floating axis may be defined by physical feature(s) (e.g., a set of bearing(s) 512, as illustrated at FIGS. 74A & 74B) or may be a virtual axis (e.g., existing in space but not directly defined by physical features, virtually defined by a four-bar linkage(s), etc.). A related discussion of pivots, including a virtual pivot point, a single pivot, and a floating drivetrain, may be found at https://www.bikeroar.com/tips/a-beginners-guide-to-mountain-bike-suspension-design. U.S. Pat. No. 3,578,378 provides a related example of pivot links used with a cover. U.S. Pat. No. 9,834,076 B2 provides related examples of a stationary pivot axis and a non-stationary or movable axis. As used herein, the word “pivotal” shall indicate rotation and/or an ability to rotate about a fixed axis, a floating axis, a movable axis, and/or a virtual axis (i.e., axes of rotation), unless further limited.

In certain embodiments, the pivotal set 50 does not include the tube 570, and the pair of pivotal mounts 500D, 500P are separately mounted directly or indirectly to the corresponding rails 460D, 460P and may jointly define the fixed axis A6. In certain embodiments, the pivotal set 50 includes a single pivotal mount 500. In certain embodiments, the pivotal set 50 is directly or indirectly attached to the cover(s)/mounting bracket(s) 174 (e.g., with the pivotal mounts 500, 500D, 500P mounted jointly or independently). The pivotal mounts 500D, 500P may be, in part or in whole, mirrored versions (i.e., enantiomorphs) of each other.

In the depicted embodiment, each of the pivotal mounts 500, 500D, 500P includes a mount housing 540. In certain embodiments, the mount housing 540 may be integrated (i.e., merged together) with the front rail mount 430F and/or the mount housing 440, 440′. As depicted at FIGS. 74A & 75B, the pivotal mount 500 further includes a pivot shaft 580 rotatably mounted to the housing 540 by a pair of the bearings 512, a spacer that separates the pair of the bearings 512, a snap ring that retains the bearings 512 and the spacer to the pivot shaft 580, a torsion spring 514, and a retaining screw 516 that retains the pivot shaft 580 to the housing 540. In the depicted embodiment, the mount housing 540 is on a vehicle side 510A of the pivot joint 510, and the pivot shaft 580 is on a cover side 510B of the pivot joint 510. In other embodiments, an alternative mount housing is on the cover side 510B of the pivot joint 510, and an alternative pivot shaft is on the vehicle side 510A of the pivot joint 510.

In the depicted embodiment, the pivot shaft 580 of each of the pivotal mounts 500D, 500P attaches to a coupling 270 (see FIGS. 13, 40, 45, 55C, & 72) at or near each side 206, 207 of the first panel 200A. As depicted, a hexagonal portion of the pivot shaft 580 engages a semi-hexagonal portion of the coupling 270 and thereby prevents relative rotation between the pivot shaft 580 and the first panel 200A, and angled surfaces of the coupling 270 (and thereby the first panel 200A) may engage angled surfaces of the pivot shaft 580 to create a zero-backlash and rattle-free connection. As shown at FIGS. 13, 40, & 72, a cap (and corresponding screws) may complete the coupling 270 and/or secure the pivot shaft 580 within the coupling 270. The first panel 200A is thereby pivotally mounted about the fixed axis A6 to the box 150 and thereby to the pickup truck 100 and may thereby be passively and/or actively rotated about the fixed axis A6 (e.g., between configurations C4 & C5, as depicted at FIGS. 6 & 9).

As described above and further described below, the panels 200B, 200C, 200D, 200x, & 200L are connected to the first panel 200A and may be selectively released from any connection to the rail/track set 40. Thus, upon release of the panels 200B, 200C, 200D, 200x, & 200L from the rail/track set 40 (e.g., release of the panel to track retainer group 34), the panels 200A, 200B, 200C, 200D, 200x, & 200L may be passively and/or actively rotated about the axis A6 (e.g., between configurations C4 & C5, as depicted at FIGS. 6 & 9). The retractable cover assembly 20 may thereby be passively and/or actively rotated about the axis A6 (e.g., between configurations C4 & C5).

As illustrated at FIG. 13, the coupling 270 (and the corresponding cap and screws) may facilitate easy removal of the retractable cover assembly 20 from the pivotal set 50 and thereby from the box 150 and/or the pickup truck 100. E.g., by removing the corresponding cap and/or screws, the coupling 270 may be separated from the pivot shaft 580, and the retractable cover assembly 20 may then be lifted off (e.g., movement M21) of the pivotal set 50 and thereby from the box 150 and/or the pickup truck 100. In other embodiments, the corresponding screws may be replaced with quick-release (e.g., cam and lever-based) screws and/or other tool-less fasteners and/or with fasteners that can be locked, require special tools, etc. for security. In the depicted embodiment, configuring the retractable cover assembly 20 at configurations C5 (see FIGS. 9 & 11) and/or C6 (see FIG. 12) provides ready access to the coupling 270, and configuring the retractable cover assembly 20 at configurations C1 (see FIG. 1) and/or C2 (see FIG. 4) restricts and/or prevents access to the coupling 270, providing security.

Upon removing the retractable cover assembly 20 from the pivotal set 50, a panels-free configuration (with the pivotal set 50 remaining) may be obtained, as illustrated at FIG. 14. This panels-free configuration may be desired for certain purposes and/or uses of the box 150 and/or the pickup truck 100. The retractable cover assembly 20 may be reinstalled by following the above method in reverse (e.g., including using movement M22). The reinstallation method may further be used for part of an initial installation of the cover arrangement 10.

A post mount arrangement 68, illustrated at FIGS. 10B, 15, 16, 50, 53, 62B, 72, & 73A, may include a pair of mounting posts 550 (i.e., first mounting members) of the pair of mount housings 540, a pair of mounting post holes 450 (i.e., mounting post receivers, second mounting members) of the pair of mount housings 440, 440′, and/or a pair of fasteners 560 (e.g., thumb screws, thumb screws with hex drive, tool-less fasteners, etc.) and may facilitate easy removal of the retractable cover assembly 20 from the rail/track set 40 and thereby from the box 150 and/or the pickup truck 100. E.g., by removing the pair of fasteners 560, the pair of mounting posts 550 may be separated from the pair of mounting post holes 450, and the retractable cover assembly 20 (along with the pivotal set 50) may then be lifted off (e.g., movement M23) of the rail/track set 40 and thereby from the box 150 and/or the pickup truck 100. In other embodiments, the fasteners 560 may be replaced with quick-release (e.g., cam and lever-based) screws and/or other tool-less fasteners and/or with fasteners that can be locked, require special tools, etc. for security. In the depicted embodiment, configuring the retractable cover assembly 20 at configurations C5 (see FIG. 10B) and/or C6 (see FIGS. 10B, 50, & 53) provides ready access to the fasteners 560, and configuring the retractable cover assembly 20 at configurations C1 (see FIG. 1) and/or C2 (see FIG. 4) restricts and/or prevents access to the fasteners 560, providing security.

Upon removing the retractable cover assembly 20 and the pivotal set 50 from the rail/track set 40, a panels-free configuration (without the pivotal set 50 remaining, but with the rail/track set 40 remaining) may be obtained, as illustrated at FIG. 16. This panels-free configuration may be desired for certain purposes and/or uses of the box 150 and/or the pickup truck 100. The retractable cover assembly 20 may be reinstalled by following the above method in reverse (e.g., including using movement M24). The reinstallation method may further be used for part of an initial installation of the cover arrangement 10. One or both of the pair of mounting post holes 450 and one or both of the pair of mounting posts 550 may be connectorized (e.g., have electrical contacts built in) and thereby make electrical connection(s) upon the pair of mounting posts 550 being inserted into the pair of mounting post holes 450.

In the depicted embodiment, the structural group 70 is adapted to provide structural integrity when typical operating loads are applied to the retractable cover arrangement 10 when at various configurations, including the configurations C1, C2, C3, C4, C5, & C6. The typical operating loads may include dynamic loads (e.g., aerodynamic, vibration, impact, opening, closing, extending, retracting, etc.) and static loads (e.g., weight) that are primarily associated with the cover arrangement 10. In certain embodiments, the structural group 70 may further provide structural integrity when additional operating loads (e.g., payloads) are applied to the retractable cover arrangement 10 when at various configurations and especially when at and/or between the configurations C1, C2, C3, & C4. The retractable cover arrangement 10 may have a payload carrying capability (e.g., the ability to carry payloads on the top side 208 of one or more of the panels 200) and thereby enhance the payload carrying capacity of the pickup truck 100 (i.e., the vehicle) as, e.g., the bottom 156 of the box/bed 150 may simultaneously carry another payload (with the end gate 160 at the closed position, at the open position, or removed). The retractable cover arrangement 10 may similarly have a walking/standing carrying capability (i.e., the ability to carry one or more people walking and/or standing on the top side 208 of one or more of the panels 200).

Attachment points (e.g., tie-downs) may be included, added, and/or removed to one or more of the panels 200, the box/bed 150, the rail/track set 40, the cover(s)/mounting bracket(s)/adapter(s) 174, etc. to secure or further secure the payloads and/or attach accessories. The rail/track set 40 may directly provide attachment points (i.e., tie-downs, locations along the rails 460, etc.) to secure or further secure the payloads. The attachment points may include multi-configuration attachment points and/or configuration specific attachment points. The configuration specific attachment points may attach to and protrude from, e.g., the passenger's side 206, the driver's side 207, and/or the top side 208 of the panel(s) 200x, 200L but may need to be removed when the cover assembly 20 is at certain configurations (e.g., C3, C4, C5, & C6).

The multi-configuration attachment points may remain when the cover assembly 20 is at multiple or all configurations and/or upon its removal. For example, in embodiments where the rail/track set 40 extends rearwardly (e.g., and thereby fills or partially fills the cut-outs 220 when the retractable cover assembly 20 is extended), the rear end 44 (e.g., at the rear mount 430R) of the rail/track set 40 may be accessible across all configurations, and an attachment point could be included at the rear end 44 (at one or both sides). For another example, the depicted first panel 200A does not nest within another panel 200x, 200L, and thus an attachment point could be included on at least the sides 206, 207, 208. If also placed along the axis A6 and on a swivel mount, the attachment points could remain at a same orientation when the first panel 200A is rotated. For yet another example, an attachment point could similarly be included on an outboard end of the pivot shaft 580, and the pivot shaft 580 could extend through a hole or a slot on the side 206, 207 of the first panel 200A. Thus, the cover assembly 20 could be removed while the attachment point remains. For still another example, an attachment point could be included on one or more of the panels 200 and not interfere (e.g. have a low profile) with various configurations.

As mentioned above, the stake pockets 176, and their attachment to the rail/track set 40, may provide the strong and/or stiff foundation for the structural group 70, in the depicted embodiment. The flange(s) 172 of the box 150, the tops 170, 170D, 170P of the box 150 and/or the cover(s)/mounting bracket(s) 174 may also provide a strong and/or stiff foundation for the structural group 70, in certain embodiments.

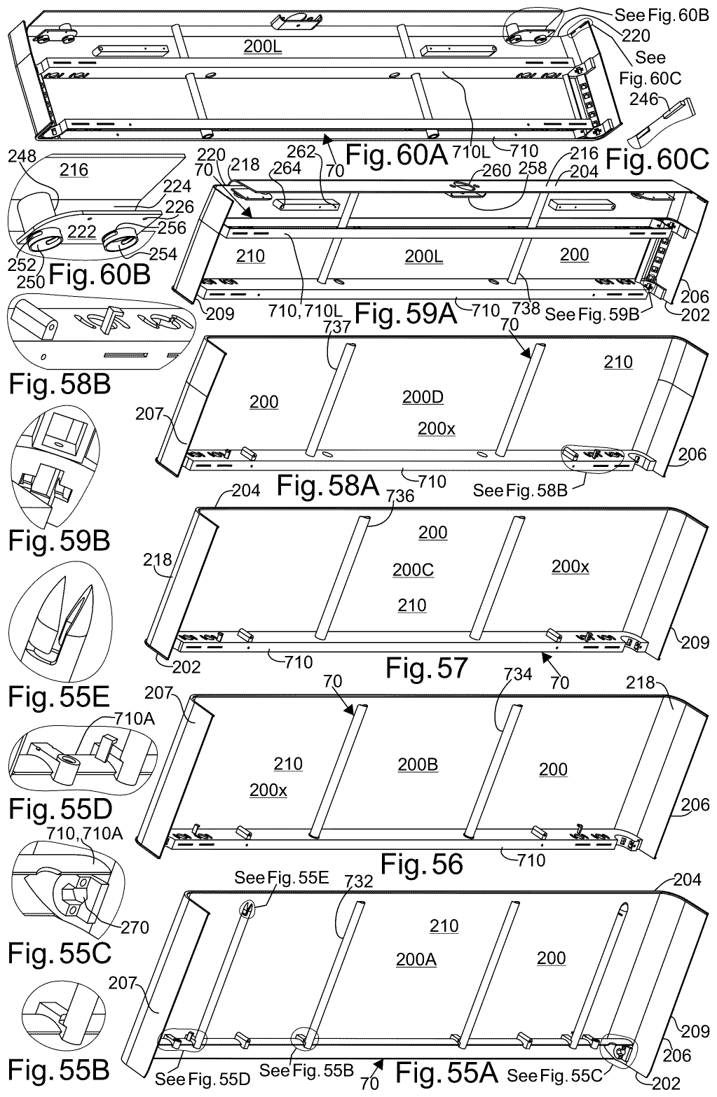

As illustrated at FIGS. 55A, 55C, 55D, 56, 57, 58A, 59A, & 60A, the panels 200A, 200B, 200C, 200D, & 200x may each include a cross beam 710 (i.e., a cross member) of the structural group 70, and the last panel 200L may include two cross beams 710 of the structural group 70. The depicted cross beam 710 of the first panel 200A is a first cross beam 710A, and the depicted second cross beam of the last panel 200L is a last cross beam 710L. The first cross beam 710A may be adapted to interoperate with the pivotal set 50 and/or the keeper group 30 and may be integrated with one of the two couplings 270 at or near each side 206, 207 of the first panel 200A. The first cross beam 710A may ride on, be reinforced by, and/or be incorporated into a tube 52 of the pivotal set 50. The depicted cross beam 710 of each of the panels 200x may be adapted to interoperate with the rail/track set 40 and/or the keeper group 30 and may be integrated with a corresponding one of the slide groups 400B, 400C, 400D at or near each side 206, 207 of the corresponding panel 200x. The depicted cross beams 710, 710L of the last panel 200L may be adapted to interoperate with the rail/track set 40 and/or the keeper group 30 and may be integrated with the slide group 400L at or near each side 206, 207 of the last panel 200L.

The depicted cross beams 710, 710A, 710L (and/or their respective cross-sections) may be relatively deep and/or strong in comparison with those of conventional cover assemblies. As depicted, neither the cross beams 710, 710A, 710L nor the panels 200, intrude into the interior 180 of the box 150 (as certain conventional cover assemblies do). The cross beams 710, 710A, 710L are efficient at transferring loads from the retractable cover assembly 20 to the rail/track set 40 (at the various configurations) and thereby to the above-mentioned foundation. The cross beam 710L may be moved closer to and/or incorporated with the rear wall 216 of the last panel 200L. The inter-panel members 215 may be configured to remain at or near the rear end 204 of the panels 200x, 200A and thereby transfer loads to the cross beam 710L, at least when at the configurations C3 & C4.

As illustrated at FIGS. 50, 51, & 54, the plurality of cross beams 710 (i.e., cross members) may be stacked together, at least when the retractable cover assembly 20 is at the configurations C3, C4, C5, & C6. As illustrated, the plurality of stacked together cross members 710 may be interconnected via interconnecting linkages 720 (i.e., interconnects). As illustrated, the plurality of stacked together cross members 710 may be interconnected via interconnecting telescoping tube sets 730, 731 (e.g., piloting member sets, interconnects, etc.).

As illustrated at FIGS. 45, 47, 50, 51, & 54, the structural group 70 may include the interconnecting linkages 720 (i.e., interconnects) that interconnect the panels 200. As depicted, the interconnecting linkages 720 each include a first link 722 and a second link 724 joined at a joint 728. The interconnecting linkages 720 may further include detents 726. The detents 726 may be varied in strength between pairs of adjacent panels 200 and thereby predetermine the opening sequence (i.e., the extension sequence) and/or the closing sequence (i.e., the retraction sequence) of the retractable cover assembly 20. The interconnecting linkages 720 may provide a travel limit, i.e., may keep adjacent panels 200 from overextending and thereby collectively keep the retractable cover assembly 20 from overextending (i.e., keep the extended length LE from being exceeded). The interconnecting linkages 720 may provide an electrical harness guide for the retractable cover assembly 20 among the various configurations. As depicted at FIGS. 50, 51, & 54, the interconnecting linkages 720 may stow at least partially within a neighboring cross beam 710.

As depicted at FIGS. 45 & 47, the interconnecting linkages 720 individually connect and stabilize neighboring pairs of the cross beams 710, 710A. A pair (e.g., a paired driver's side linkage 720 and passenger's side linkage 720) of the interconnecting linkages 720 may jointly connect and stabilize the neighboring pairs of the cross beams 710, 710A. Collectively, the connected and stabilized neighboring pairs of cross beams 710, 710A connect and stabilize the retractable cover assembly 20 (from the first panel 200A to the last panel 200L and including the intermediate panels 200x), as described below in detail for various embodiments (which may be intermixed on the same retractable cover arrangement 10). The structural group 70 (i.e., coordination group) may include the individual, the pair, or a plurality of the interconnecting linkages 720 that interconnect adjacent pairs (i.e., neighboring pairs) of the panels 200.

The first link 722 may connect with an adjacent cross beam 710, 710A at a joint 727. The second link 724 may connect with an adjacent cross beam 710 at a joint 729. As depicted, the joints 727 & 729 may both be in close proximity to each other on a common cross beam 710 and may thereby form (i.e., be included on) a compound joint 725. In other embodiments, the joints 727 & 729 at a common cross beam 710 may be combined (e.g., operate on a same joint pivot axis, a same joint pivot point, and/or a related joint pivot point and axis). The joints 727, 728, 729 are rotatable joints and may be cylindrical joints, or a combination of cylindrical and spherical joints. In the depicted embodiment, the joints 727, 728, 729 are all cylindrical joints. (Replacing one of the cylindrical joints with a spherical joint may relieve binding.) As depicted, the interconnecting linkages 720 keep the interconnected pair of neighboring cross members 710, 710A oriented with respect to each other (i.e., keep cylindrical joint axes parallel with each other) and may aid in smooth and appropriate movement of the retractable cover assembly 20 (e.g. along with the keeper group 30 and/or the rail/track set 40).

The illustrated interconnecting linkages 720 are located at the passenger's side, and mirrored versions (i.e., enantiomorphs) of those shown may be included on the driver's side. In mirrored embodiments, the pairs of the interconnecting linkages 720 may be symmetric about a longitudinal center plane of the retractable cover arrangement 10 and/or the retractable cover assembly 20 and thereby move opposite from (i.e., symmetric with) each other when the retractable cover assembly 20 moves (e.g., between the extended configuration C1, C2 and the retracted configuration C3, C4).

Alternatively (or additionally), a translated copy of the illustrated interconnecting linkages 720 may be included on the driver's side. In translated embodiments, the pairs of the interconnecting linkages 720 may move in unison with each other when the retractable cover assembly 20 moves (e.g., between the extended configuration C1, C2 and the retracted configuration C3, C4). The joints 728 of a pair of the interconnecting linkages 720 that interconnect the adjacent pair of the cross members 710 and panels 200 may move in unison toward, e.g., the first side 206 when the retractable cover assembly 20 moves (e.g., from the extended configuration C1, C2 toward the retracted configuration C3, C4), or, alternatively, the joints 728 of the pair of the interconnecting linkages 720 may move in unison toward the second side 207. In such translated linkage embodiments, a connecting link (not shown) may connect the joints 728 of corresponding pairs of the interconnecting linkages 720 (and/or connect corresponding links 722 together and/or connect corresponding links 724 together). In this way, the interconnected pairs of cross members 710, 710A may be kept parallel with each other and thereby at least help keep the adjacent panels 200 parallel to each other between and at the various configurations and thereby may aid in smooth and appropriate movement of the retractable cover assembly 20. As the connecting link (not shown) further guides and/or constrains the cross members 710, 710A and thereby the panels 200, it may be possible to simplify the keeper group 30 (e.g., by not necessarily connecting every cross member 710 to the rail/track set 40 with, e.g., the track retainer group 34).

As illustrated at FIGS. 45 & 47, the interconnecting linkages 720 may transfer loads via bending moments along structural beams (especially when at the extended configuration C1, C2). As illustrated at FIGS. 50 & 54, the interconnecting linkages 720 may transfer loads via torsion along the structural beams (especially when at the retracted configurations C3, C4 and in a panels pivoted configuration C5, C6). To further transfer loads, especially at or near the configurations C3, C4, C5, C6, the structural/coordination group 70 may further include one or more piloting joints 730, 731 with a male portion and a female portion (or equivalent mating pairs). The male portion may be included on one of the cross members 710 of the corresponding interconnected pair of cross members, and the female portion may be included on another of the cross members 710 of the corresponding interconnected pair of cross members. A single tube (e.g., tube 734 at FIG. 51) may provide both a male portion and a female portion. In certain embodiments, the piloting joint 730, 731 is continuously engaged when the retractable cover assembly 20 moves between the various configurations. In other embodiments (not shown), the piloting joint is engaged at least when the retractable cover assembly 20 is at the retracted configurations C3, C4 and the pivoted configuration C5, C6. In still other embodiments (not shown), the piloting joint is engaged only when the corresponding interconnected pair of cross members 710 are within a predetermined distance from each other (e.g., within 1 inch, 2 inches, 3 inches, 5 inches, 10 inches, etc.) and may be used for alignment when approaching the retracted configuration C3. The piloting joints 730, 731 may further be used to keep the stacked cross beams 710 (and panels 200) together (e.g., when removed by the movements M21, M23, discussed above).

As illustrated at FIGS. 45, 47, 50, 51, & 52, the structural/coordination group 70 may include one or more sets 730, 731 of interconnecting telescoping tubes 732, 734, 736, 737, & 738 that interconnect the panels 200 via the cross members 710, 710A, 710L. As depicted, the one or more sets 730, 731 of the interconnecting telescoping tubes 732, 734, 736, 737, & 738 connect and stabilize neighboring cross beams 710, 710A. As depicted at FIGS. 50 & 51, the telescoping tubes sets 730, 731 may individually connect and stabilize neighboring pairs of the cross beams 710, 710A. As suggested at FIGS. 55A, 56, 57, 58A, 59A, & 60A, a pair (e.g., paired driver's side and passenger's side tubes) of the interconnecting tubes 732, 734, 736, 737, & 738 may jointly connect and stabilize the neighboring pairs of the cross beams 710, 710A. Collectively, the connected and stabilized neighboring pairs of cross beams 710, 710A connect and stabilize the retractable cover assembly 20 (from the first panel 200A to the last panel 200L and including the intermediate panels 200x). The structural group 70 (i.e., coordination group) may include the individual, the pair, or a plurality of the interconnecting tubes 732, 734, 736, 737, & 738 that interconnect adjacent pairs (i.e., neighboring pairs) of the panels 200.

As depicted, the telescoping tube sets 730, 731 include a first tube 732, 734, 737 and a second tube 734, 736, 738 that is telescopingly connected to the first tube 732, 734, 737. The first tube 732, 734, 737 is connected to a first cross member 710, 710A of the corresponding interconnected pair of cross members. The second tube 734, 736, 738 is connected to a second cross member 710 of the corresponding interconnected pair of cross members. A free end of the first tube 734 and a free end of the second tube 736 may extend from a mounted end in the same direction. Alternatively, a free end of the first tube 737 and a free end of the second tube 738 may extend from a mounted end in the opposite directions. In the depicted embodiment, the structural/coordination group 70 includes two sets 730, 731. In other embodiments, the structural/coordination group 70 may include a single set or more than two sets.

The actuator group 80 may implement movements of the retractable cover arrangement 10. The movements may be powered (e.g., by motors, solenoids, ball screws, timing belts, combinations thereof, etc.) and/or may be manual (e.g., pushed, pulled, and/or rotated by an operator). In certain embodiments, such powered movements may be back driven by the operator. To illustrate and/or describe the principles of the present disclosure, especially as depicted in the example embodiments shown at the figures, twelve movements have been correspondingly labeled M0, M1, M2, M3, M4, M5, M6, M7, M8, M9, M10, and M11. Other unlabeled movements: may be illustrated at the figures, may be described herein but not necessarily illustrated at the figures, and/or will become apparent to one of ordinary skill in the art in view of the present disclosure. The labeling of the movements does not necessarily indicate any required use or order of use, and partial movements may be used. Such movements may occur across a group of interconnected components, and thus various components may be labeled with the same movement notation. The various components may transform the movement (e.g., from a rotational movement to a linear movement). The embodiments illustrated at the figures generally have the movements M0 through M5 driving reconfigurations C1 through C6 and the movements M6 through M11 driving reconfigurations C6 through C1. As the movements M6 through M11 generally drive configurations C6 through C1 in reverse order, these movement labels have been put within parentheses at the figures for notational purpose. As depicted, certain of the movements may have differential relationships with other movements.

The above movements may involve rotations about various axes. These include: axis A1—actuating handle deploy/stow, axis A2—actuating handle rotate, axis A3D—cable pulley (driver's side), axis A3P—cable pulley (passenger's side), axis A4—inboard actuating axis, axis A4P—inboard actuating axis, axis A5—outboard actuating axis, axis A5P—outboard actuating axis, and the above-mentioned axis A6—cover pivot axis.

FIGS. 1, 2A, 4, 5, and 62A illustrate the extension keeper group 31 and a set of track/rail keepers 310 selectively retaining the cover assembly 20 at an extended (deployed) and locked configuration C1 (i.e., a deployed configuration or a locked deployed configuration) of the cover arrangement 10. In the depicted embodiment, a pair of first keepers 302 (see FIGS. 2B, 5, and 62B) of a pair of extension locks 300 of the extension keeper group 31 are included on and actuated with the pair of covers 230, 230P, 230D, and a pair of second keepers 304 (see FIGS. 5 and 14) of the pair of extension locks 300 are included on the rail/track set 40. In the depicted embodiment, the keepers 302 and 304 abut each other when at configuration C1 and thereby lock (i.e., hold, retain, etc.) the cover assembly 20 at configuration C1. In the depicted embodiment, first keeper elements 312 (i.e., releasable retainers, e.g., rollers 402) of the set of track/rail keepers 310 is in rolling contact with second keeper elements 314 (e.g., the tracks 480 of the tube 470 of the rail/track set 40). FIG. 2A illustrates the keepers 310 at configuration C1 and thereby further retaining the cover assembly 20 to the rail/track set 40.

In other embodiments, the pair of extension locks 300 may not necessarily be used and/or included, and the cover assembly 20 may be held at configuration C1 by other means (e.g., by an actuator(s), a detent(s), a magnet(s), etc.). In other embodiments, the pair of extension locks 300 may engage and disengage via dedicated component(s) (e.g., a bolt and a strike feature).

As depicted, the extension locks 300 (and the covers 230) may be unlocked (i.e., released) by moving the keepers 302 by movement M1 (see FIG. 2A) and may be locked (i.e., relocked, retained, etc.) by moving the keepers 302 by movement M10 (see FIG. 5). In the depicted embodiment, link 830 movements M1 & M10 may provide actuation of the keepers 302. FIGS. 4 and 5 illustrate the extension locks 300 unlocked and the cover arrangement 10 at an extended (deployed) and unlocked configuration C2 (i.e., a deployed configuration or an unlocked deployed configuration). Movement M1 thus reconfigures the cover arrangement 10 from configuration C1 to configuration C2, and movement M10 thus reconfigures the cover arrangement 10 from configuration C2 to configuration C1.

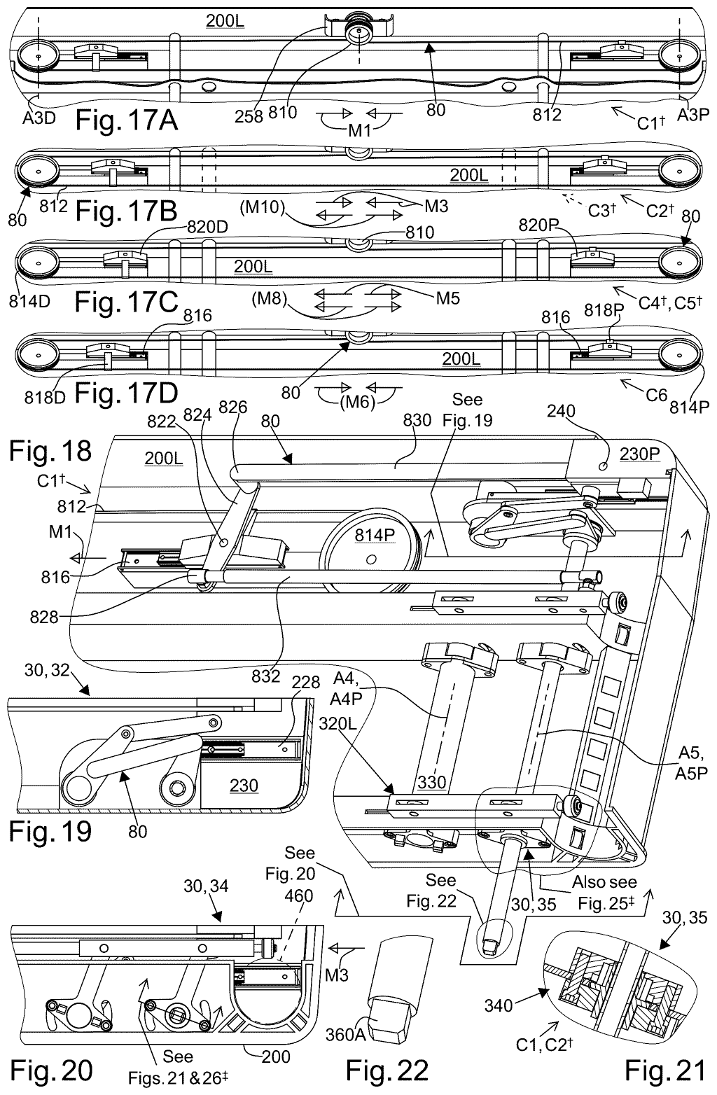

As depicted, movements M1 & M10 are achieved by preliminarily unlocking (if necessary) a lock 808 (i.e., a keyed lock) and raising a handle 806 of the actuating handle assembly 800 with movement M0 about the axis A1 (see FIG. 3A) and thereby configuring the handle assembly 800 as shown at FIG. 3B. Handle 806 movement MI about the axis A2 (see FIG. 3C) may be achieved by rotation of the handle 806 relative to a base 802 and about an axle 804 of the handle assembly 800. Handle 806 movement MI causes spool 810 to rotate and thereby causes cable 812 loop movement MI about a cable loop defined by spools 814D, 814P. FIG. 17A (before) and FIG. 17B (after) illustrate cable 812 loop movement M1 causing pivot mounts 820, 820D, 820P symmetric inward movement M1. FIG. 18 (before) and FIG. 23 (after) illustrate pivot mounts 820 symmetric inward movement M1 causing link 830 inward movement M1. (The panel-track retainer keeper group 35 is locked as the cover arrangement 10 is at configurations C1 & C2 and thereby prevents movements M3 & M8 (see FIGS. 7 & 8) and significant movements of link 832.) Links 830 inward movements MI correspondingly release the pair of first keepers 302 from the pair of second keepers 304 and changes configuration C1 to C2.

Handle 806 movement M10 (see FIG. 3B), which correspondingly engages the pair of first keepers 302 with the pair of second keepers 304 and changes configuration C2 to C1 may be achieved by reversing the above-described movements M1. Lowering the handle 806 with movement M11 about the axis A1 (see FIG. 3B) thereby configures the handle assembly 800 as shown at FIG. 3A. The lock 808 can be locked, if desired, and thereby prevent at least movements M1 & M10.

Upon the extension locks 300 being unlocked, the cover assembly 20 may be changed from configuration C2 to a retracted and retained configuration C3, illustrated at FIG. 6, by moving the cover assembly 20 in direction M2 (see FIGS. 4 & 5). The cover assembly 20 may be returned (i.e., changed) from configuration C3 to configuration C2 of the cover arrangement 10 by moving the cover assembly 20 in direction M9 (see FIG. 6). The movements M2 and/or M9 may be manual and/or actuated by actuator(s) 80. Manual actuation may be accomplished by pushing and/or pulling the handle 806 (and/or the cover 200L). The cover assembly 20 is retained to the rail/track set 40 in configurations C1, C2, and C3 and therefore is suitable for use when driving, etc. In the depicted embodiment, the cover assembly 20 is retained to the rail/track set 40 by the set of track/rail keepers 310. FIG. 7 illustrates the keepers 310 at the retracted and retained configuration C3 and thereby retaining the cover assembly 20 to the rail/track set 40 (configurations C1 and C2 may be similarly retained by the keepers 310).

The keepers 310 may release the cover assembly 20 from the rail/track set 40 by moving the keepers 310 in inward direction M3 (see FIG. 7) and may retain the cover assembly 20 to the rail/track set 40 by moving the keepers 310 in outward direction M8 (see FIG. 8). In the depicted embodiment, a set of linkages 320 (e.g., 4-bar linkages) may provide actuation. FIG. 8 illustrates the keepers 310 at a retracted and released configuration C4 of the cover arrangement 10.

When the cover arrangement 10 reaches the retracted and retained configuration C3, the panel-track retainer keeper group 35 may be unlocked by the link locks 340 of the keeper group 35 being released (see FIG. 21—link lock 340 locked—and FIG. 26—link lock 340 unlocked). In addition, at configurations C3, C4, C5, & C6 linkage arrangements 320, 320B, 320C, 320D, & 320L (2×4-bar linkage) are connected together and operate in unison with each other by activation of link connectors 332 (e.g., a male component 332A engaging a female component 332B). A link connector 330 may keep the 2×4-bar linkages continuously engaged.

When the cover arrangement 10 is at configurations C3 and C4, movements M3 & M8 may be achieved by deploying the handle 806 (if needed), as described above, and rotating the handle 806 relative to the base 802 about the axis A2. As with movements M1 & M10, handle 806 movement M3 causes the spool 810 to rotate and thereby causes the cable 812 loop movement M3 about the cable loop. FIG. 17B (before) and FIG. 17C (after) illustrate the cable 812 loop movement M3 causing the pivot mounts 820, 820D, 820P symmetric inward movement M3. FIG. 23 (before) and FIG. 27 (after) illustrate pivot mounts 820 symmetric inward movement M3 causing link 832 inward movement M3. (The panel-track retainer keeper group 35 is unlocked as the cover arrangement 10 is at configurations C3 & C4 and thereby allows movements M3 & M8 (see FIGS. 7 & 8) and free movement of the link 832. As the covers 230 are against the stop 248 and further indirectly held by the pivot keeper detent group 39D, the link 830 does not move.) Links 832 inward movements M3 correspondingly releases the pair of the keepers 310 (via toggling the linkage arrangements 320) from the rail/track set 40 and changes configuration C3 to C4.

Handle 806 movement M8, which correspondingly engages the pair of the keepers 310 with the rail/track set 40 and changes configuration C4 to C3 may be achieved by reversing the above-described movements M3. Stowing the handle 806 (if desired), as described above, may also be done. The lock 808 can be locked, if desired, and thereby prevent at least movements M3 & M8. A separate lock 808 (and a separate key) may be used to control configurations that are accessible to a given key(s) holder.

Upon releasing the keepers 310, the cover assembly 20 may be moved (i.e., changed) from configuration C4 to a pivoted/tilted configuration C5 of the cover arrangement 10 and thereby positioned adjacent a cab portion 110 of the pickup truck 100, as illustrated at FIG. 9, by moving the cover assembly 20 in direction M4 (see FIG. 6 for direction illustration). The cover assembly 20 may be returned (i.e., changed) from configuration C5 to configuration C4 by moving in direction M7 (see FIG. 9). The movements M4 and/or M7 may be manual and/or actuated by actuator(s) 80. Manual actuation may be accomplished by pushing and/or pulling the handle 806 (and/or the cover 200L). The cover assembly 20 is not retained to the rail/track set 40 at the C4 and C5 configurations. However, a set of keepers 350 and/or a set of keepers 380 keeps the cover assembly 20 retracted (stowed) and together with a first panel 200A, which is attached to a pivot 50. (Configurations C1, C2, C3, and C6 may be similarly retained by the pivot 50.)

The cover assembly 20 may be secured pivoted/tilted adjacent the cab 110 by a pivot/tilt lock(s) 390. In particular, the pivot/tilt lock 390 may be moved in direction M5 to secure the cover assembly at configuration C6 of the cover arrangement 10. The cover arrangement may be returned to configuration C5 of the cover arrangement 10 by moving the pivot/tilt lock 390 in direction M6. Actuation may be performed by actuator 360 (i.e., toggling tilt link actuator).

When the cover arrangement 10 is at configurations C5 and C6, movements M5 & M6 may be achieved by deploying the handle 806 (if needed), as described above, and rotating the handle 806 relative to the base 802 about the axis A2. As with movements M1 & M10, handle 806 movement M5 causes the spool 810 to rotate and thereby causes the cable 812 loop movement M5 about the cable loop. FIG. 17C (before) and FIG. 17D (after) illustrate the cable 812 loop movement M5 causing the pivot mounts 820, 820D, 820P symmetric outward movement M5. FIG. 27 (before) and FIG. 32 (after) illustrate pivot mounts 820 symmetric outward movement M5 causing link 830 outward movement M5. (The panel-track retainer keeper group 36 and engaging surface 390A are kept as the cover arrangement 10 is at configurations C5 or C6 and thereby prevents movement M8 (see FIGS. 11, 12, 31, & 50) and also prevents movement of the track/rail keepers 310.) Links 830 outward movements M5 correspondingly engages the pivot/tilt lock 390 (via toggling tilt link actuator 360 which is connected to linkage 370 by the engagement of drive 360A with socket 360B) and changes configuration C5 to C6.

Handle 806 movement M6, which correspondingly disengages the pair of the pivot/tilt locks 390 (and engaging surfaces 390A) from rests 390B of the rail/track set 40 and changes configuration C6 to C5, may be achieved by reversing the above-described movements M5. Stowing the handle 806 (if desired), as described above, may also be done. The lock 808 can be locked, if desired, and thereby prevent at least movements M5 & M6.

As depicted, the rail/track set 40 is actuated by motor(s) 840 (e.g., electric motor(s)). An encoder 842 may be used to monitor and/or coordinate the motor(s) 840.

As depicted, the pivotal set 50 is actuated by motor(s) 850 (e.g., electric motor(s)). In the depicted embodiment, torque of the motor(s) are multiplied by gearbox(es) 854. An encoder 852 may be used to monitor and/or coordinate the motor(s) 850. In the depicted embodiment, torsional spring(s) 514 provide a counterbalance to weight of the cover assembly 20. The torsional spring 514 is illustrated at a wound configuration 514W and at an unwound configuration 514U.

In certain embodiments, the panel to track retainer group 34 (e.g., including at least one releasable retainer) may release one or more of the panels 200 from the rail/track set 40, and the retractable cover assembly 20 may be tilted/pivoted without being retracted (e.g., the cover assembly 20 may be at or near the extended (deployed) configurations C1 or C2 and tilted/pivoted while at or near the extended length LE) and thereby configured at a tilted extended configuration. In certain embodiments, the cover assembly 20 may be supported and/or retained by a prop rod when tilted/pivoted (e.g., when at the tilted extended configuration). The tilted extended configuration may be used to access the interior 180 of the box 150. The retractable cover assembly 20 may be returned from the tilted extended configuration to, e.g., the extended (deployed) configurations C1 or C2, and the panel to track retainer group 34 may retain the one or more of the panels 200 to the rail/track set 40.

The retractable cover arrangement 10 may exclude certain of the above-mentioned features and/or certain of the above-mentioned features may be optional. Certain commonality between base models and fully optioned models may be maintained. Certain options may be added after the initial purchase and/or build. For example, a non-powered version may be converted to a powered version. Commonality between versions and option levels may thereby provide the ability to upsell, to maintain common parts (and inventory), upgrade after the sale, etc.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred.

1. A cover arrangement for a vehicle, the cover arrangement comprising:
a plurality of panels adapted to be assembled into a retractable cover assembly, the retractable cover assembly adapted to extend to a panels extended configuration and adapted to retract to a panels retracted configuration;
at least one pivotal mount;
at least one track; and
at least one releasable retainer adapted to releasably retain at least one panel of the plurality of panels to the at least one track at least when the retractable cover assembly is reconfigured between the panels extended configuration and the panels retracted configuration;
wherein a first panel of the plurality of panels is adapted to mount to the at least one pivotal mount and is thereby adapted to, at least in part, reconfigure the retractable cover assembly between the panels retracted configuration and a panels pivoted configuration; and
wherein the at least one releasable retainer is adapted to release the at least one panel of the plurality of panels from the at least one track at least when the retractable cover assembly is reconfigured from the panels retracted configuration to the panels pivoted configuration.

2-4. (canceled)

5. The cover arrangement of claim 1, further comprising:
at least one releasable keeper adapted to selectively keep and release the retractable cover assembly at the panels extended configuration;
wherein the panels extended configuration is a panels extended and kept configuration when the at least one releasable keeper keeps the retractable cover assembly from being retracted; and
wherein the panels extended configuration is a panels extended and released configuration when the at least one releasable keeper releases the retractable cover assembly to be retracted.

6-7. (canceled)

8. The cover arrangement of claim 1, further comprising at least one releasable holder adapted to selectively hold and release the retractable cover assembly at the panels pivoted configuration;
wherein the panels pivoted configuration is a released panels pivoted configuration when the at least one releasable holder releases the retractable cover assembly to be unpivoted; and
wherein the panels pivoted configuration is a held panels pivoted configuration when the at least one releasable holder holds the retractable cover assembly from being unpivoted.

9-10. (canceled)

11. The cover arrangement of claim 1, further comprising at least one configuration selector adapted to reconfigure the retractable cover assembly between any of the configurations, wherein the at least one configuration selector is a single configuration selector.

12.-20. (canceled)

21. The cover arrangement of claim 1, wherein the at least one releasable retainer is adapted to release the at least one panel of the plurality of panels from the at least one track at least when the retractable cover assembly is reconfigured from the panels extended configuration to a tilted extended configuration.

22-26. (canceled)

27. The cover arrangement of claim 1, wherein the at least one track is included on at least one corresponding rail of the cover arrangement.

28. The cover arrangement of claim 27, wherein the at least one rail is adapted to attach to the vehicle via at least one corresponding stake hole of the vehicle.

29-46. (canceled)

47. The cover arrangement of claim 1, wherein the vehicle is a pickup truck and the retractable cover assembly substantially covers a box of the pickup truck at least when at the panels extended configuration and substantially allows access to an interior of the box at least when at the panels retracted configuration and/or at the panels pivoted configuration.

48. A cover arrangement for a vehicle, the cover arrangement comprising:
a retractable cover assembly including a plurality of panels, the retractable cover assembly adapted to extend to an extended length between a first end and a second end of the retractable cover assembly and thereby to a panels extended configuration and adapted to retract to a retracted length between the first end and the second end and thereby to a panels retracted configuration; and
a coordination group including a plurality of cross members and at least one interconnect adapted to connect at least one corresponding interconnected pair of cross members of the plurality of cross members;
wherein the at least one interconnect is adapted to maintain a relative orientation between the at least one corresponding interconnected pair of cross members at least when the retractable cover assembly moves between the panels extended configuration and the panels retracted configuration.

49. The cover arrangement of claim 48, wherein each cross member of the at least one corresponding interconnected pair of cross members is integrated with a corresponding panel of a corresponding pair of panels of the plurality of panels.

50-51. (canceled)

52. The cover arrangement of claim 48, wherein:
the at least one interconnect is at least one interconnect linkage that includes a first link and a second link rotatably connected to the first link at a first joint;
the first link is rotatably connected to a first cross member of the corresponding interconnected pair of cross members at a second joint; and
the second link is rotatably connected to a second cross member of the corresponding interconnected pair of cross members at a third joint.

53. The cover arrangement of claim 48, wherein:
each panel of the plurality of panels extends between a first end and a second end;
a first cross member of the corresponding interconnected pair(s) of cross members is positioned adjacent the first end of a first panel of a corresponding pair of panels of the plurality of panels; and
a second cross member of the corresponding interconnected pair(s) of cross members is positioned adjacent the first end of a second panel of the corresponding pair of panels of the plurality of panels.

54-57. (canceled)

58. The cover arrangement of claim 53, wherein:
the at least one interconnect is at least one interconnect linkage that includes a first link and a second link rotatably connected to the first link at a first joint;
the first link is rotatably connected to a first cross member of the corresponding interconnected pair of cross members at a second joint; and
the second link is rotatably connected to a second cross member of the corresponding interconnected pair of cross members at a third joint.

59-60. (canceled)

61. The cover arrangement of claim 58, wherein at least one of the corresponding first and second cross members includes a channel-shaped portion adapted to receive at least a portion of the first link(s) at least when the retractable cover assembly is at the panels retracted configuration.

62-74. (canceled)

75. The cover arrangement of claim 48 wherein:
the at least one interconnect is at least one telescoping tube set that includes a first tube and a second tube telescopingly connected to the first tube;
the first tube is connected to a first cross member of the corresponding interconnected pair of cross members; and
the second tube is connected to a second cross member of the corresponding interconnected pair of cross members.

76-77. (canceled)

78. The cover arrangement of claim 48, wherein the plurality of cross members includes a plurality of stacked together cross members at least when the retractable cover assembly is at the panels retracted configuration.

79. (canceled)

80. The cover arrangement of claim 48, further comprising a pair of tracks, wherein the plurality of cross members includes at least one slidable cross member with a pair of slides adapted to respectively slide along the pair of tracks, wherein the pair(s) of slides is (are) (a) pair(s) of roller slides including a set of rollers adapted to respectively roll along the pair of tracks.

81-86. (canceled)

87. A cover arrangement for a box of a pickup truck, the cover arrangement comprising:
a cover;
a post mount arrangement including a pair of mounting posts and a pair of corresponding mounting post receivers adapted to respectively releasably receive the pair of mounting posts and thereby, at least in part, releasably secure the cover to the pickup truck.

88. The cover arrangement of claim 87, further comprising a pair of rails, wherein at least one of the pair of mounting post receivers is included on the pair of rails.

89. (canceled)

90. The cover arrangement of claim 88, wherein the pair of rails is adapted to attach to the pickup truck via at least a pair of corresponding stake holes of the pickup truck.

91-95. (canceled)

96. The cover arrangement of claim 88, further comprising at least one releasable retainer adapted to, at least in part, releasably retain the cover to the pair of rails, wherein the at least one releasable retainer is adapted to release the cover from the pair of rails at least when the cover is reconfigured from a panels retracted configuration to a panels pivoted configuration.

97. The cover arrangement of claim 96, further comprising a keeper arrangement adapted to keep the cover retracted at least when the cover is removed from the pickup truck via releasing the post mount arrangement.

98-100. (canceled)
